(19) United States
(12) Patent Application Publication
(10) Pub. No.: US 2024/0343864 A1
(43) Pub. Date: Oct. 17, 2024

(54) POLYESTERS AND POLYAMIDES AND THEIR PREPARATION THROUGH IN SITU HYDRATION OF TRANS-3-HEXENEDIOIC ACID

(71) Applicant: IOWA STATE UNIVERSITY RESEARCH FOUNDATION, INC., Ames, IA (US)

(72) Inventors: Jean-Philippe TESSONNIER, Ames, IA (US); Eric William COCHRAN, Ames, IA (US); Brent Howard SHANKS, Ames, IA (US); Dustin GANSEBOM, Lenexa, KS (US); Sanaz ABDOLMOHAMMADI, Suwanee, GA (US); Michael J. FORRESTER, Ames, IA (US)

(21) Appl. No.: 18/682,576

(22) PCT Filed: Jul. 8, 2022
(86) PCT No.: PCT/US22/36497

§ 371 Date: Feb. 9, 2024

Related U.S. Application Data
(60) Provisional application No. 63/232,045, filed on Aug. 11, 2021.

(51) Int. Cl. C08G 69/26; C08G 63/54; C08G 63/78; C08G 69/28; D06M 15/507; D06M 15/59

(52) U.S. Cl. CPC C08G 69/265; C08G 63/54; C08G 63/78; C08G 69/28; D06M 15/507; D06M 15/59

(57) ABSTRACT

The present application relates to a polymer comprising a moiety of formula: (I) wherein R, R¹, X, n, o, s, m, i, and j are as described herein and salts thereof and to a process of preparing such a polymer.

This application claims the priority benefit of U.S. Provisional Patent Application Ser. No. 63/232,045, filed Aug. 11, 2021, which is hereby incorporated by reference in its entirety.

This invention was made with government support under IIP1701000 and DMR1626315 awarded by National Science Foundation and DE-EE0008492 awarded by United States Department of Energy. The government has certain rights in the invention.

### FIELD

The present application relates to polyesters and polyamides and their preparation through in situ hydration of trans-3-hexenedioic acid.

### BACKGROUND

The use of agricultural products and residues as feedstocks for chemicals has been pursued for many years as concerns over the sustainability of chemical manufacturing have grown increasingly prominent. However, despite extensive effort, widespread commercial adoption of biomass as a chemical feedstock has not materialized. Achieving a sustainable chemical industry necessitates a reassessment of the prevailing view that sustainability is the principal goal of biomass conversion technology. Many of the first such efforts focused on drop-in chemicals that directly compete with existing petrochemicals and fuels, including short and long chain fatty acids, phenolics, methane, and ethanol (Lipinsky, “Chemicals from Biomass: Petrochemical Substitution Options,” Science 212 (4502): 1465-1471 (1981); Levy et al., “Biorefining of Biomass to Liquid Fuels and Organic Chemicals,” Enzyme Microb. Technol. 3 (3): 207-215 (1981); Clausen et al., “Organic Acids from Biomass by Continuous Fermentation,” Chem Eng Prog U.S. 80:12 (1984); McGinnis et al., “Conversion of Biomass into Chemicals with High-Temperature Wet Oxidation,” Ind. Eng. Chem. Prod. Res. Dev. 22 (4): 633-636 (1983)). The Department of Energy has promoted this approach by releasing a list of the top value-added chemicals that can be derived from biomass (Werpy et al., “Top Value Added Chemicals from Biomass: Volume I—Results of Screening for Potential Candidates from Sugars and Synthesis Gas,” DOE/GO-102004-1992 National Renewable Energy Lab., Golden, CO (US) (2004); Bozell et al., “Technology Development for the Production of Biobased Products from Biorefinery Carbohydrates—the US Department of Energy's “Top 10” Revisited,” Green Chem. 12 (4): 539-554 (2010)). The drop-in replacement approach, while appealing from a technical perspective as the markets and infrastructure for utilizing these products already exist, suffers from vulnerability to enduring price volatility in crude oil and natural gas. Consequently, interest in drop-in renewable fuels has historically vacillated with the price of oil (Zhang, “The Links Between the Price of Oil and the Value of US Dollar,” Int. J. Energy Econ. Policy 3 (4): 341-351 (2013); Wyman, “BIOMASS ETHANOL: Technical Progress, Opportunities, and Commercial Challenges,”. Annu. Rev. Energy Environ. 24 (1): 189-226 (1999)). Over the past decade, unfavorable economics and low oil prices have led to the bankruptcy, closure, or liquidation of numerous biorenewables companies and plants (Songer, “Verdezyne Becomes Latest Victim of Liquidation, as Investors Withdraw Funding,” Bio Market Insights (2018); Schill, “Western Biomass up for Sale; Blue Sugars Files Bankruptcy,” Ethanol Producer Magazine (2013); Voegele, “Shell Files Bid to Purchase Abengoa's Cellulosic Ethanol Plant,” Biomass Magazine (2016); Dent, “What the Oil Price Crash Means for Bioplastics,” IDTechEx (2020); McCoy, “Succinic Acid, Once a Biobased Chemical Star, is Barely Being Made,” C&En Chemical and Engineering News (2019)). In the long term, oil prices will continue to receive downward pressure from renewable energy adoption, making it increasingly difficult for the drop-in replacement approach to be economically viable. To enhance the adoption of biomass as a chemical feedstock, an alternative approach is required.

To create sustainable markets for biomass, it has been proposed to exploit its unique properties to yield novel chemicals that were previously inaccessible through crude oil (Shanks et al., “Bioprivileged Molecules: Creating Value from Biomass,” Green Chem., 19 (14): 3177-3185 (2017)). Novel bio-based chemicals have untapped potential and no competition from the petrochemical industry. In contrast to drop-in chemicals, capitalizing on the unique functionality of biomass to add value to petrochemical products has demonstrated efficacy. The prototypical example of this approach is furfural, which was serendipitously produced by the Quaker Oat company from oat hulls while attempting to enhance its digestibility as a cattle feed. At the time, no market existed for furfural, but by combining extensive experimentation and structure-function knowledge, applications in phenolic resins, refining, and usage as a solvent were established (Brownlee et al., “Industrial Development of Furfural,” Ind. Eng. Chem. 40 (2):201-204 (1948); Peters, “The Furans: Fifteen Years of Progress,” Ind. Eng. Chem. 28 (7): 755-759 (1936)). Furthermore, furfural was derivatized into other furanic compounds, broadening its usage (Peters, “The Furans: Fifteen Years of Progress,” Ind. Eng. Chem. 28 (7): 755-759 (1936)). Bio-based furfural was integrated into the existing petrochemical industry as a complement, not as a substitute. The fact that furfural is still produced via biomass deconstruction nearly a century later is a testament to the tenacity of novel products derived from biomass (Brownlee et al., “Industrial Development of Furfural,” Ind. Eng. Chem. 40 (2): 201-204 (1948); Dalvand et al., “Economics of Biofuels: Market Potential of Furfural and Its Derivatives,” Biomass Bioenergy 115:56-63 (2018)). Unfortunately, novel biobased chemical development faces technical barriers, despite its potential. Novel chemicals have no existing markets. As such, it is useful to identify an application beforehand to narrow the investigatory universe and guide research efforts. However, a dearth of structure-function knowledge encumbers rational design. Molecular targets cannot be identified, so a strictly retrosynthetic approach is inadequate. To overcome these challenges, a forward-synthetic approach based on “bioprivileged” molecules was recently described. Bioprivileged molecules are defined as “biology-derived chemical intermediates that can be efficiently converted to a diversity of chemical products including both novel molecules and drop-in replacements” (Shanks et al., “Bioprivileged Molecules: Creating Value from Biomass,” Green Chem., 19 (14): 3177-3185 (2017)). The bioprivileged approach utilizes diversity-oriented synthesis to leverage the unique functionality of biomass and develop novel products. Furthermore, since they can be readily converted into drop-in chemicals, bioprivileged molecules can be viably produced regardless of market conditions by subsidizing the direct replacements with high value novel species. During periods of high demand, bioprivileged molecules can profitably be used to produce drop-in chemicals. The versatility of the bioprivileged approach keeps biomass conversion resilient in diverse economic conditions.

Another approach considered for advancing the adoption of biomass feedstocks is the “bioadvantaged” approach, which focuses on biomass valorization for polymer manufacturing. Bioadvantaged polymers are defined to offer unique performance advantages to their petrochemical counterparts by incorporating minimally modified biologically-produced monomers that are inaccessible to the petrochemical industry (Hernández et al., “The Battle for the “Green” Polymer. Different Approaches for Biopolymer Synthesis: Bioadvantaged vs. Bioreplacement,” Org. Biomol. Chem. 12 (18): 2834-2849 (2014)). Unsaturated triglycerides, for example, have been extensively studied. Functionalization of the unsaturated bond with an epoxide and subsequent ring opening with alpha-beta unsaturated carboxylic acids such as acrylic acid and itaconic acid enabled the synthesis of thermosets, rubbers, styrenic block copolymers, and polylactic acid blends (Hernandez et al., “The Battle for the “Green” Polymer. Different Approaches for Biopolymer Synthesis: Bioadvantaged vs. Bioreplacement,” Org. Biomol. Chem. 12 (18): 2834-2849 (2014); Lin et al., “Self-Assembly of Poly(Styrene-Block-Acrylated Epoxidized Soybean Oil) Star-Brush-Like Block Copolymers,” Macromolecules 53 (18): 8095-8107 (2020); Li et al., “Itaconic Acid as a Green Alternative to Acrylic Acid for Producing a Soybean Oil-Based Thermoset: Synthesis and Properties,” ACS Sustain. Chem. Eng. 5(1):1228-1236 (2017); Mauck et al., “Biorenewable Tough Blends of Polylactide and Acrylated Epoxidized Soybean Oil Compatibilized by a Polylactide Star Polymer,” Macromolecules 49 (5): 1605-1615 (2016)). Polyols have received much attention as well. Renewable polyols have been used to produce hydrogels, polyurethanes, and polyesters (Bruggeman et al., “Biodegradable Xylitol-Based Polymers,” Adv. Mater. 20 (10): 1922-1927 (2008); Gang et al., “Development of High Performance Polyurethane Elastomers Using Vanillin-Based Green Polyol Chain Extender Originating from Lignocellulosic Biomass,” ACS Sustain. Chem. Eng. 5 (6): 4582-4588 (2017); Furtwengler et al., “Renewable Polyols for Advanced Polyurethane Foams from Diverse Biomass Resources,” Polym. Chem. 9 (32): 4258-4287 (2018); Lang et al., “Review on the Impact of Polyols on the Properties of Bio-Based Polyesters,” Polymers 12 (12): 2969 (2020)). The unique functional combinations of these polymers offer the advantages necessary to encourage their adoption. For example, acrylated epoxidized soybean oil has been used to toughen polylactic acid, increase asphalt processability, and reduce asphalt thermal cracking (Mauck et al., “Biorenewable Tough Blends of Polylactide and Acrylated Epoxidized Soybean Oil Compatibilized by a Polylactide Star Polymer,” Macromolecules 49 (5): 1605-1615 (2016); Chen et al., “Laboratory Investigation of Using Acrylated Epoxidized Soybean Oil (AESO) for Asphalt Modification,” Constr. Build. Mater. 187:267-279 (2018)). Polyol polyesters readily biodegrade and are biocompatible (Lang et al., “Review on the Impact of Polyols on the Properties of Bio-Based Polyesters,” Polymers 12 (12): 2969 (2020)). Without these advantages, there would be no impetus for assimilation into the preexisting chemical industry. Attempting to produce legacy polymers from biomass forces competition solely on price, leading to suppressed prices. Considering half of all shale oil wells are profitable below $40/bbl, the minimum price required to cover operating expenses can be as low as $10/bbl, and the largest expense for commodity chemical production is feedstock, it is challenging for bio-based drop-in chemicals to compete economically (Passwaters, “Half of Producing Shale Oil Wells are Profitable at $40/bbl, Analyst Says,” S&P Global Market Intelligence (2020); “Oil and Gas Activity Grows Modestly as Oil Price Jumps,” Dallas Fed Energy Survey, Federal Reserve Bank of Dallas (2019); Boulamanti et al., “Production Costs of the Chemical Industry in the EU and Other Countries: Ammonia, Methanol and Light Olefins,” Renew. Sustain. Energy Rev. 68:1205-1212 (2017)). Developing polymers and chemicals that complement and enhance the established petrochemical portfolio is the best way to establish longstanding integration of biomass in the chemical industry.

The present application is directed to overcoming these and other deficiencies in the art.

### SUMMARY

One aspect of the present application relates to a polymer comprising a moiety of formula:

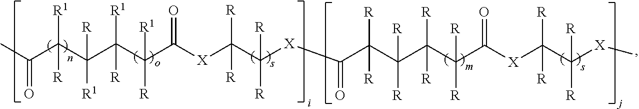

wherein
X is NH or O;
R is independently H or OH;
each R¹ is independently H or OH;
i is 1 to 1,000,000;
j is 1 to 1,000,000;
m is 1 to 30;
n is 1 to 30;
is 1 to 30; and
s is independently 1 to 50;
with the proviso that at least one R¹ is OH,
or a salt thereof.

Another aspect of the present application relates to a process for preparation of a polymer comprising a moiety of formula:

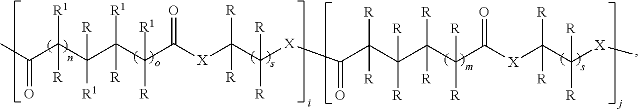

wherein
X is NH or O;
R is independently H or OH;
each R¹ is independently H or OH;
i is 1 to 1,000,000;
j is 1 to 1,000,000;
m is 1 to 30;
n is 1 to 30;
o is 1 to 30; and
s is independently 1 to 50;
with the proviso that at least one R¹ is OH,
or a salt thereof.

This process includes:
providing a compound having the structure of formula (II):

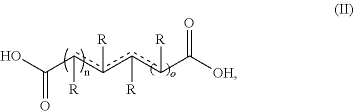

wherein each [symbol] is independently a single or a double bond with no adjacent double bonds, and wherein at least one [symbol] is a double bond;
providing a compound having the structure of formula (III):

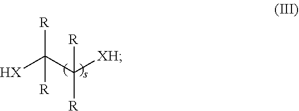

providing a compound having the structure of formula (IV):

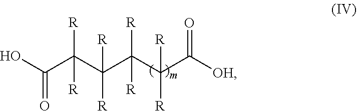

and
reacting the compound of formula (II), the compound of formula (III), and the compound of formula (IV) under conditions effective to produce the polymer.

Another aspect of the present application relates to a textile treatment composition comprising the polymer according to the present application.

Another aspect of the present application relates to a method for impregnating textiles, comprising impregnating a textile with a composition comprising the polymer according to the present application.

The bioprivileged and bioadvantaged strategies complement each other, and combining them can further strengthen the value-driven adoption of biomass as a chemical feedstock. One molecule at the nexus of these approaches is muconic acid. Muconic acid is a C6 alpha-gamma unsaturated diacid that can be fermented from glucose and lignin by bacteria and yeast (Xie et al., “Biotechnological Production of Muconic Acid: Current Status and Future Prospects,” Biotechnol. Adv. 32 (3): 615-622 (2014); Vardon et al., “Adipic Acid Production from Lignin,” Energy Environ. Sci. 8 (2): 617-628 (2015); Bentley et al., “Engineering Glucose Metabolism for Enhanced Muconic Acid Production in Pseudomonas Putida KT2440,” Metab. Eng. 59:64-75 (2020); Suastegui et al., “Combining Metabolic Engineering and Electrocatalysis: Application to the Production of Polyamides from Sugar,” Angew. Chem. Int. Ed. 55 (7): 2368-2373 (2016); Suástegui et al., “Multilevel Engineering of the Upstream Module of Aromatic Amino Acid Biosynthesis in Saccharomyces Cerevisiae for High Production of Polymer and Drug Precursors,” Metab. Eng. 42:134-144 (2017), which are hereby incorporated by reference in their entirety). Using chemical catalysis, muconic acid can be derivatized into numerous commodity chemicals currently derived from petroleum, including, adipic acid (AA), hexamethylenediamine (HMDA), caprolactone, caprolactam, and 1,6-hexanediol (Beerthuis et al., “Catalytic Routes Towards Acrylic Acid, Adipic Acid and ε-Caprolactam Starting from Biorenewables,” Green Chem. 17 (3): 1341-1361 (2015), which is hereby incorporated by reference in its entirety). Muconic acid has also been derivatized into the novel species trans-3-hexenedioic acid (t3HDA) using an electrochemical process having 98% selectivity, 96% conversion, and nearly 100% faradaic efficiency (Matthiesen et al., “Electrochemical Conversion of Muconic Acid to Biobased Diacid Monomers,” ACS Sustain. Chem. Eng. 4 (6): 3575-3585 (2016); Matthiesen et al., “Electrochemical Conversion of Biologically Produced Muconic Acid: Key Considerations for Scale-Up and Corresponding Technoeconomic Analysis,” ACS Sustain. Chem. Eng. 4 (12): 7098-7109 (2016), which are hereby incorporated by reference in their entirety). Technoeconomic analysis of this process suggested that t3HDA can be produced for $2.13/kg (Matthiesen et al., “Electrochemical Conversion of Biologically Produced Muconic Acid: Key Considerations for Scale-Up and Corresponding Technoeconomic Analysis,” ACS Sustain. Chem. Eng. 4 (12): 7098-7109 (2016), which is hereby incorporated by reference in its entirety). Considering its appealing cost, t3HDA is a promising candidate for bioadvantaged polyamides. Furthermore, t3HDA's double bond can serve as a target for further functionalization. Grafting different functional moieties to t3HDA can lead to other bioadvantaged polymers with tailored properties. Prior to examining this potential, however, an assessment of the influence of count loading on semicrystalline polymer properties is necessary.

The present application demonstrates how the incorporation of bioadvantaged monomers in low loadings can lead to legacy semicrystalline polymers with value-added properties. By using low loadings, a high degree of crystallinity can be maintained, thereby resulting in copolymers with comparable thermal and mechanical properties to their unloaded counterparts. Furthermore, the amorphous region can be selectively altered by comonomer loading and that judicious selection of co-unit functionality can result in desirable properties. Nylon 6,6 loaded with t3HDA have been chosen as a model case for this approach due to the commercial relevance of Nylon 6,6 and the structural similarity of t3HDA to adipic acid, a Nylon 6,6 monomer. These “bioadvantaged nylons” (BANs) were first screened over the entire composition range to identify the critical loading level where BAN properties begin to deviate significantly from those of Nylon 6,6. BANs with acceptable properties were upgraded to commercial quality and fully characterized to assess the influence of co-unit loading on crystalline structure, thermal properties, and mechanical properties.

The present application describes the approach for selectively modifying the properties of semicrystalline polymers by introducing “bioadvantaged” co-units. With this approach, the unique functionality of biomass can be leveraged to tailor the properties of the amorphous phase of semicrystalline polymers with minimal impact on crystallinity and thermomechanical properties. As a model case, PA 6,6 copolyamides were produced using the bioadvantaged monomer trans-3-hexenedioic acid (t3HDA). The analogous structure of t3HDA to adipic acid, a PA 6,6 monomer, allows for seamless integration. Screening over the entire composition range identified the t3HDA loading (20 mol %) beyond which properties deviate appreciably from Nylon 6,6. Once identified, copolyamides of suitable compositions were upgraded to commercial quality and fully characterized to assess the influence of co-unit loading and polymer structure on thermal and mechanical properties. Samples were characterized using gel permeation chromatography (GPC), proton nuclear magnetic resonance spectroscopy (¹H NMR), heteronuclear single quantum coherence spectroscopy (HSQC), wide-angle X-ray scattering (WAXS), differential scanning calorimetry (DSC), thermogravimetric analysis (TGA), dynamic mechanical analysis (DMA), tensile testing, flexural testing, and water absorption testing. t3HDA units were shown to hydrate during the harsh polycondensation to 3-hydroxyhexanedioic acid (3HHDA) and fully incorporate into the polymer backbone. Loading levels up to 20% were shown to have comparable thermal and mechanical properties in the dry state, yet moisture absorption—a known method for improving the toughness, yield strain, and elongation of polyamides—was enhanced by over 100% at 20% loading. This study on bioadvantaged copolymers elucidates the governing structure-function principles that can be leveraged to forward value-added renewable polymers.

### BRIEF DESCRIPTION OF THE DRAWINGS

FIG. 1 shows proton nuclear magnetic resonance spectra of BAN salts.

FIG. 2 shows fourier transform infrared spectra of BAN salts.

FIG. 3 is a graph showing gel permeation chromatograms of bioadvantaged nylons (BANs) with different trans-3-hexenedioic acid (t3HDA) loadings. Samples were made in two batches and analyzed separately.

FIG. 4 is 1H NMR spectra of BAN0 (black), BAN5 (green), BAN10 (orange), and BAN20 (blue). Peaks characteristic of Nylon 6,6 are marked with PA, and peaks attributed to t3HDA loading are marked with *.

FIG. 5 is a magnified spectrum showing the novel BAN20 signals and the proposed structure. Overlapping end group signals were subtracted out. Numbers correspond to tentative proton assignments. The spectrum was taken in a solution of 66 v/v % trifluoroacetic anhydride and 33 v/v % CDCl₃ with tetramethylsilane (TMS) as an internal standard. 1H NMR (600 MHz) 4.37 (tt, J=8.1, 3.7 Hz, 1H), 3.43 (dd, J=17.6, 3.6 Hz, 1H), 3.11-3.06 (m, 1H), 3.03 (dd, J=17.6, 9.3 Hz, 1H), 2.78 (dt, J=17.6, 8.6 Hz, 1H), 2.69 (ddd, J=17.9, 10.0, 5.1 Hz, 1H), 2.56-2.45 (m, 1H), 1.91 (ddt, J=13.8, 9.3, 4.6 Hz, 1H).

FIG. 6 is an overlaid HSQC spectra of BAN0 (black) and BAN10 (orange). Cross peaks corresponding to HMDA proximal to 3HHDA are labeled.

FIG. 7 is a heteronuclear single quantum coherence (HSQC) spectrum of BAN0 showing both positive phase (black) and negative phase (red).

FIG. 8 is a HSQC spectrum of BAN5 showing both positive phase (black) and negative phase (red).

FIG. 9 is a HSQC spectrum of BAN10 showing both positive phase (black) and negative phase (red).

FIG. 10 is a HSQC spectrum of BAN20 showing both positive phase (black) and negative phase (red).

FIG. 11 is a graph showing wide angle X-ray scattering diffractograms of BANs at room temperature (25° C.) showing the intrasheet (100) peak and the intersheet (010/110) doublet. Diffractograms have been smoothed for clarity.

FIGS. 12A-H show three-dimensional temperature dependent wide-angle X-ray scattering (WAXS) patterns for BAN0 (FIG. 12A), BAN5 (FIG. 12B), BAN10 (FIG. 12C), and BAN20 (FIG. 12D) and the respective plots for BANs exhibiting (100) (black squares) and (010/110) (red circles) d spacings through heating (left) and cooling (right) (FIGS. 12E-H). Samples were cycled through heating (back) and cooling (front). Orange traces indicate the Brill transition temperature.

FIG. 13 is a graph showing BAN differential scanning calorimetry traces. Melting point (Tₘ) and crystallization temperature (T_{c}) decrease and peak breadth increases as t3HDA loading is increased.

FIGS. 14A-B are graphs showing commercial PA66 (FIG. 14A) and BAN (FIG. 14B) thermogravimetric traces. Thermogravimetric analysis experiments were conducted under nitrogen atmosphere using a 10° C./min ramp rate.

FIG. 15 is a graph showing dynamic mechanical analysis traces for BANs with different t3HDA loadings.

FIG. 16 is a graph showing tensile plots for Commercial PA66. Curves marked with * were excluded as outliers.

FIGS. 17A-D are graphs showing tensile plots for BAN0 (FIG. 17A), BAN5 (FIG. 17B), BAN10 (FIG. 17C), and BAN20 (FIG. 17D). Curves marked with * were excluded as outliers.

FIGS. 18A-B are graphs showing comparison of tensile property data for homemade (BAN0) and commercial (Commercial PA66) Nylon 6,6. FIG. 18A shows tensile modulus and toughness and FIG. 18B shows max stress and max strain.

FIGS. 19A-B are graphs showing tensile property data comparison of BANs with differing t3HDA loadings. ISO 527-2 1BB bars were analyzed using 7-10 replicates. FIG. 19A shows tensile modulus and toughness and FIG. 19B shows max stress and max strain.

FIG. 20 show flexural plots for Commercial PA66.

FIGS. 21A-D are flexural plots for BAN0 (FIG. 21A), BAN5 (FIG. 21B), BAN10 (FIG. 21C), and BAN20 (FIG. 21D).

FIGS. 22A-B are graphs showing flexural property data comparison of BAN0 to Commercial PA66 (FIG. 22A) and BANs of differing t3HDA loading (FIG. 22B). Tests were performed on annealed Izod bars in triplicate (standard ASTM D790).

FIGS. 23A-B are graphs showing water absorption comparison of BAN0 to Commercial PA66 (FIG. 23A) and BANs with differing t3HDA loadings (FIG. 23B). Triplicate Izod bars were soaked in 18 MΩ water for 12 days.

FIG. 24 is a graph showing BAN differential scanning calorimetry traces revealing evidence of a second order phase transition attributed to a hydrogen bond network. Exemplary dashed lines are provided to clarify the transition, which becomes more pronounced with increasing t3HDA loading.

### DETAILED DESCRIPTION

As used above, and throughout the description herein, the following terms, unless otherwise indicated, shall be understood to have the following meanings. If not defined otherwise herein, all technical and scientific terms used herein have the same meaning as is commonly understood by one of ordinary skill in the art to which this technology belongs. In the event that there is a plurality of definitions for a term herein, those in this section prevail unless stated otherwise.

The term “salts” means the inorganic, and organic base addition salts, of compounds of the present application. Suitable metal salts include the sodium, potassium, calcium, barium, zinc, magnesium, and aluminum salts.

The term “copolymer” refers to a polymer derived from more than one species of monomer.

The term “statistically defined manner” refers to the repeat unit sequence distribution (RUSD) of the polymer, which is determined by the polymerization chemistry, the number and nature of co-monomers, and the reaction conditions under which the polymer is formed. For any polymer, the RUSD can be represented by a probability function Pᵢ(j) that indicates the likelihood that the identity of the repeat unit at location j along the chain contour is i. Common RUSD classifications include, but are not limited to, random (Pᵢ=constant) and block (e.g., Pᵢ(j<f)=0 and Pᵢ(j≥f)=1 and given fixed contour coordinate f). RUSD prediction and measurement are discussed in most polymer chemistry texts (e.g., Hiemenz and Lodge, Polymer Chemistry, 2^{nd} Ed., Boca Raton Fl., CRC Press (2007), which is hereby incorporated by reference in its entirety).

The term “alternating copolymer” or “alternating polymer” refers to a copolymer consisting of two or more species of monomeric units that are arranged in an alternating sequence (in which every other building unit is different (-M₁M₂-)ₙ.

The term “random copolymer” or “random polymer” refers to a copolymer in which there is no definite order for the sequence of the different building blocks (-M₁M₂M₁M₁M₂M₁M₂M₂-).

The term “statistical copolymer” or “statistical polymer” refers to a copolymer in which the sequential distribution of the monomeric units obeys known statistical laws.

The term “block copolymer” or “block polymer” refers to a macromolecule consisting of long sequences of different repeat units. Exemplary block polymers include, but are not limited to AₙBₘ, AₙBₘAₘ, AₙBₘCₖ, or AₙBₘCₖAₙ.

One aspect of the present application relates to a polymer comprising a moiety of formula:

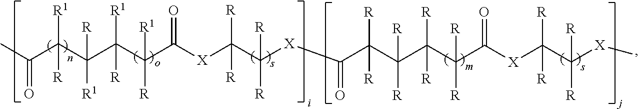

wherein
X is NH or O;
R is independently H or OH;
each R¹ is independently H or OH;
i is 1 to 1,000,000;
j is 1 to 1,000,000;
m is 1 to 30;
n is 1 to 30;
o is 1 to 30; and
s is independently 1 to 50;
with the proviso that at least one R¹ is OH,
or a salt thereof.

In some embodiments, the polymer according to the present application:

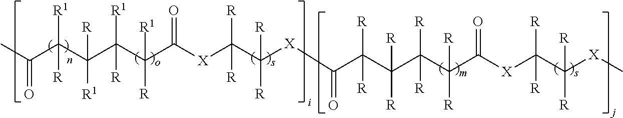

can further have one or more of the polymer blocks of formula

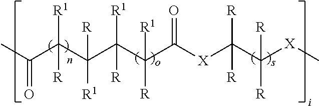

and/or

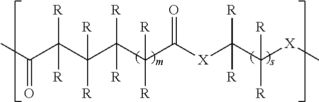

attached to the end of either or both sides of the polymer chain

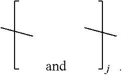

For example, the polymer according to the present application can have a structure of formula -Aᵢ-Bⱼ-, -Aᵢ-Bⱼ-Aᵢᵢ-Bⱼⱼ-, -Aᵢ-Bⱼ-Aᵢᵢ-Bⱼ-Aᵢᵢᵢ-Bⱼⱼⱼ-, -B-Aᵢ-Bⱼ-Aᵢᵢ-Bⱼⱼ-Aᵢᵢᵢ-Bⱼⱼⱼ-, - B-Aₕ-Bⱼ-A-Bⱼⱼ-Aᵢᵢᵢ-Bⱼⱼⱼ-, -B-Aᵢ-Bⱼ-A-B-Aᵢᵢᵢ-Bⱼⱼⱼ-, -Bⱼ-Aᵢ-Bⱼ-Aᵢᵢᵢ-Bⱼⱼ-Aᵢᵢᵢ-Bⱼⱼⱼ-, or -Aᵢ-Bⱼ-Aᵢᵢ-Bⱼⱼ-Aᵢᵢᵢ-Bⱼⱼⱼ-A-, wherein A is

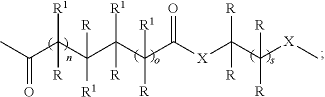

### B is

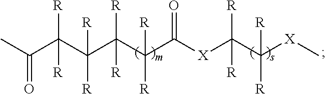

each i, ii, iii . . . iₖ can be the same or different and are independently selected from 1 to 1,000,000; each j, jj, jjj . . . jₘ can be the same or different and are independently selected from 1 to 1,000,000; k and m are 1,000,000; wherein the sum of i, ii, iii . . . ix is 1 to 1,000,000, and the sum of j, jj, jjj . . . jₘ is 1 to 1,000,000.

In some embodiments, the polymer has the structure of formula (I):

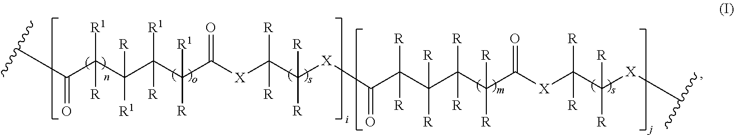

wherein [symbol] is a terminal group of the polymer.

According to the present application, i is from 1 to 1,000,000. For example, i is from 2 to 1,000,000, i is from 10 to 1,000,000, i is from 20 to 1,000,000, i is from 25 to 1,000,000, i is from 30 to 1,000,000, i is from 40 to 1,000,000, i is from 50 to 1,000,000, i is from 75 to 1,000,000, i is from 100 to 1,000,000, i is from 150 to 1,000,000, i is from 200 to 1,000,000, i is from 250 to 1,000,000, i is from 300 to 1,000,000, i is from 350 to 1,000,000, i is from 400 to 1,000,000, i is from 450 to 1,000,000, i is from 500 to 1,000,000, i is from 550 to 1,000,000, i is from 600 to 1,000,000, i is from 650 to 1,000,000, i is from 700 to 1,000,000, i is from 750 to 1,000,000, i is from 800 to 1,000,000, i is from 850 to 1,000,000, i is from 900 to 1,000,000, i is from 950 to 1,000,000, i is from 1,000 to 1,000,000, i is from 1,500 to 1,000,000, i is from 2,000 to 1,000,000, i is from 3,000 to 1,000,000, i is from 4,000 to 1,000,000, i is from 5,000 to 1,000,000, i is from 6,000 to 1,000,000, i is from 7,000 to 1,000,000, i is from 8,000 to 1,000,000, i is from 9,000 to 1,000,000, i is from 10,000 to 1,000,000, i is from 20,000 to 1,000,000, i is from 30,000 to 1,000,000, i is from 40,000 to 1,000,000, i is from 50,000 to 1,000,000, i is from 100,000 to 1,000,000, i is from 250,000 to 1,000,000, i is from 500,000 to 1,000,000, i is from 750,000 to 1,000,000. For example, i is from 2 to 850,000, i is from 10 to 700,000, i is from 50 to 600,000, i is from 100 to 500,000, i is from 250 to 500,000, i is from 500 to 500,000, i is from 1,000 to 500,000, i is from 2,000 to 500,000, i is from 10,000 to 500,000, i is from 100,000 to 500,000.

According to the present application, j is from 1 to 1,000,000. For example, j is from 2 to 1,000,000, j is from 10 to 1,000,000, j is from 20 to 1,000,000, j is from 25 to 1,000,000, j is from 30 to 1,000,000, j is from 40 to 1,000,000, j is from 50 to 1,000,000, j is from 75 to 1,000,000, j is from 100 to 1,000,000, j is from 150 to 1,000,000, j is from 200 to 1,000,000, j is from 250 to 1,000,000, j is from 300 to 1,000,000, j is from 350 to 1,000,000, j is from 400 to 1,000,000, j is from 450 to 1,000,000, j is from 500 to 1,000,000, j is from 550 to 1,000,000, j is from 600 to 1,000,000, j is from 650 to 1,000,000, j is from 700 to 1,000,000, j is from 750 to 1,000,000, j is from 800 to 1,000,000, j is from 850 to 1,000,000, j is from 900 to 1,000,000, j is from 950 to 1,000,000, j is from 1,000 to 1,000,000, j is from 1,500 to 1,000,000, j is from 2,000 to 1,000,000, j is from 3,000 to 1,000,000, j is from 4,000 to 1,000,000, j is from 5,000 to 1,000,000, j is from 6,000 to 1,000,000, j is from 7,000 to 1,000,000, j is from 8,000 to 1,000,000, j is from 9,000 to 1,000,000, j is from 10,000 to 1,000,000, j is from 20,000 to 1,000,000, j is from 30,000 to 1,000,000, j is from 40,000 to 1,000,000, j is from 50,000 to 1,000,000, j is from 100,000 to 1,000,000, j is from 250,000 to 1,000,000, j is from 500,000 to 1,000,000, j is from 750,000 to 1,000,000. For example, j is from 2 to 850,000, j is from 10 to 700,000, j is from 50 to 600,000, j is from 100 to 500,000, j is from 250 to 500,000, j is from 500 to 500,000, j is from 1,000 to 500,000, j is from 2,000 to 500,000, j is from 10,000 to 500,000, j is from 100,000 to 500,000.

In one embodiment, i and j represent number average degrees of polymerization for repeat units of formula I that are distributed throughout the polymer chain in a statistically defined manner.

In another embodiment, the polymer is a statistical polymer.

In another embodiment, the polymer is a random polymer.

In yet another embodiment, the polymer is an alternating polymer.

In a further embodiment, the polymer is a block polymer.

In one embodiment, X is NH.

In another embodiment, the polymer comprises a moiety of formula:

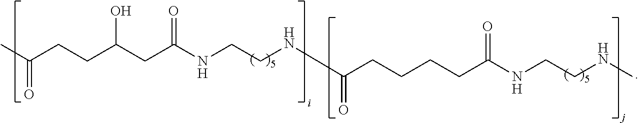

In another embodiment, the polymer comprises a moiety of formula:

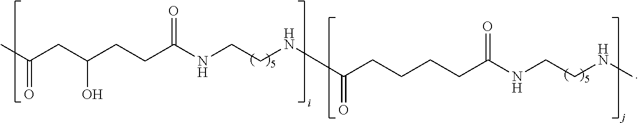

In yet another embodiment, the polymer has the structure of formula (Ia):

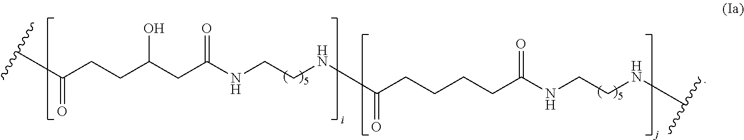

In a further embodiment, the polymer has the structure of formula (Ib):

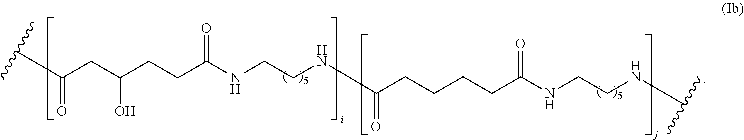

According to the present application, the polymer can have a number average molecular weight (Mₙ) above 1 kDa, above 2 kDa, above 3 kDa, above 4 kDa, above 5 kDa, above 6 kDa, above 7 kDa, above 8 kDa, above 9 kDa, above 10 kDa, above 11 kDa, above 12 kDa, above 13 kDa, above 14 kDa, above 15 kDa, above 16 kDa, above 17 kDa, above 18 kDa, above 19 kDa, above 20 kDa, above 21 kDa, above 22 kDa, above 23 kDa, above 24 kDa, above 25 kDa, above 26 kDa, above 27 kDa, above 28 kDa, above 29 kDa, or above 30 kDa.

According to the present application, the polymer can have a number average molecular weight (Mₙ) ranging from 0.1 kDa to 200 kDa. For example, the polymer can have a number average molecular weight (Mₙ) from 0.1 kDa to 40 kDa, from 0.5 kDa to 35 kDa, from 1 kDa to 35 kDa, from 2 kDa to 30 kDa, from 3 kDa to 30 kDa, from 4 kDa to 30 kDa, from 5 kDa to 30 kDa, from 6 kDa to 30 kDa, from 7 kDa to 30 kDa, from 8 kDa to 30 kDa, from 9 kDa to 30 kDa, from 10 kDa to 30 kDa, from 11 kDa to 30 kDa, from 12 kDa to 30 kDa, from 13 kDa to 30 kDa, from 14 kDa to 30 kDa, from 15 kDa to 30 kDa, from 2 kDa to 20 kDa, from 3 kDa to 20 kDa, from 4 kDa to 20 kDa, from 5 kDa to 20 kDa, from 6 kDa to 20 kDa, from 7 kDa to 20 kDa, from 8 kDa to 20 kDa, from 9 kDa to 20 kDa, from 10 kDa to 20 kDa, from 11 kDa to 20 kDa, from 12 kDa to 20 kDa, from 13 kDa to 20 kDa, from 14 kDa to 20 kDa, from 15 kDa to 20 kDa, from 2 kDa to 15 kDa, from 3 kDa to 15 kDa, from 4 kDa to 15 kDa, from 5 kDa to 15 kDa, from 6 kDa to 15 kDa, from 7 kDa to 15 kDa, from 8 kDa to 15 kDa, from 9 kDa to 15 kDa, from 10 kDa to 15 kDa, from 1 kDa to 10 kDa, from 2 kDa to 10 kDa, from 3 kDa to 10 kDa, from 4 kDa to 10 kDa, or from 5 kDa to 10 kDa.

The polymers of the present application can be prepared according to the schemes described below. Polymers of formula 4 can be prepared by an initial polycondensation reaction (oligomer formation) between acids 1 and 2 and the compound of formula 3 followed by a polymerization step (polymer formation) (Schemes 1-3). The initial polycondensation reaction can be carried out neat or in a variety of solvents, for example in water, methanol (MeOH), ethanol (EtOH), isopropanol (i-PrOH), dimethylformamide (DMF), or other such solvents or in a mixture of such solvents. The initial polycondensation reaction (oligomer formation) can be carried out at a temperature of 100° C. to 300° C., at a temperature of 125° C. to 275° C., at a temperature of 150° C. to 250° C., at a temperature of 175° C. to 250° C., at a temperature of 200° C. to 250° C., or at a temperature of 200° C. to 240° C. The polymer formation step can be performed neat or in a variety of solvents, for example in phenols, cresols, hexafluoro-isopropanol, dimethylformamide (DMF) or other such solvents or in a mixture of such solvents. The final step in the polymerization (polymer formation) reaction can be carried out at a temperature of 100° C. to 400° C., at a temperature of 125° C. to 375° C., at a temperature of 150° C. to 350° C., at a temperature of 175° C. to 325° C., at a temperature of 200° C. to 300° C., at a temperature of 225° C. to 300° C., at a temperature of 250° C. to 300° C., or at a temperature of 260° C. to 300° C.

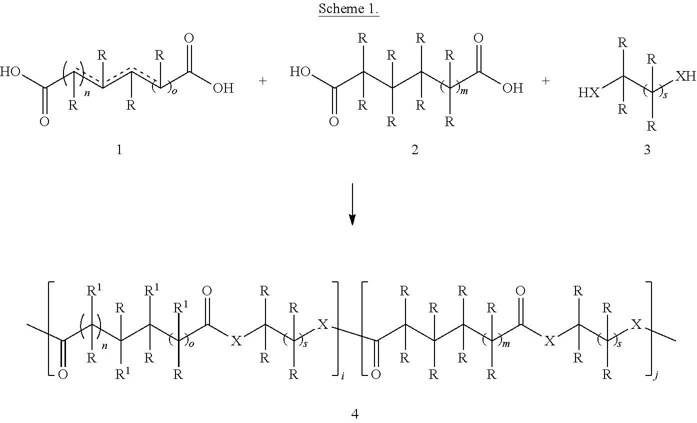

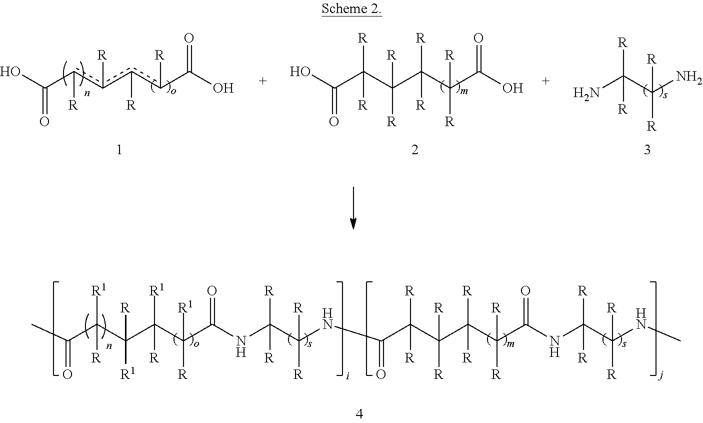

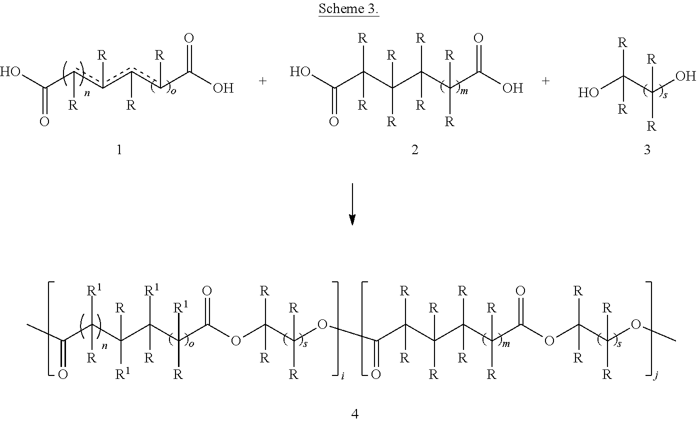

In some embodiments, the polymers of formula 4 can be prepared by first preparing the salts between acid 1 and the compound of formula 3 (salt 1) and acid 2 and the compound of formula 3 (salt 2), followed by an initial polycondensation reaction (oligomer formation) and then a polymerization step. The salt formation can be carried out in a variety of solvents, for example in water, methanol (MeOH), ethanol (EtOH), isopropanol (i-PrOH), dimethylformamide (DMF), or other such solvents or in a mixture of such solvents. The salt formation can be carried out at a temperature of 20° C. to 100° C., at a temperature of 20° C. to 75° C., at a temperature of 20° C. to 50° C., at a temperature of 20° C. to 45° C., at a temperature of 20° C. to 40° C., at a temperature of 25° C. to 40° C., at a temperature of 30° C. to 40° C., at a temperature of 35° C. to 40° C., or at a temperature of 30° C. to 45° C. The salt formation can be carried out for 10 min to 24 hours, for 20 min to 20 hours, for 30 min to 18 hours, for 45 min to 12 hours, for 1 hour to 6 hours, or for 1 hour to 3 hours. The polycondensation reaction can be carried out neat or in a variety of solvents, for example in water, methanol (MeOH), ethanol (EtOH), isopropanol (i-PrOH), dimethylformamide (DMF), or other such solvents or in a mixture of such solvents. The initial polycondensation reaction can be carried out at a temperature of 100° C. to 300° C., at a temperature of 125° C. to 275° C., at a temperature of 150° C. to 250° C., at a temperature of 175° C. to 250° C., at a temperature of 200° C. to 250° C., or at a temperature of 200° C. to 240° C. The polymer formation step can be performed neat or in a variety of solvents, for example in phenols, cresols, hexafluoro-isopropanol, dimethylformamide (DMF) or other such solvents or in a mixture of such solvents. The final step in the polymerization (polymer formation) reaction can be carried out at a temperature of 100° C. to 400° C., at a temperature of 125° C. to 375° C., at a temperature of 150° C. to 350° C., at a temperature of 175° C. to 325° C., at a temperature of 200° C. to 300° C., at a temperature of 225° C. to 300° C., at a temperature of 250° C. to 300° C., or at a temperature of 260° C. to 300° C.

Polycondensation reaction and polymer formation step can be performed in the same reaction vessel or different reaction vessels. In some embodiments, the reaction vessel was vented at least once during the process of polycondensation reaction and polymer formation step.

In some embodiments, polycondensation reaction and polymer formation step can be performed under an inert atmosphere (e.g., under a nitrogen atmosphere or an argon atmosphere).

In some embodiments, polycondensation reaction and polymer formation step can be performed under pressure. For example, the polycondensation reaction and polymer formation step can be performed at a pressure for the inert gas from 50 psig to 300 psig, from 75 psig to 250 psig, from 100 psig to 200 psig, or from 125 psig to 200 psig. In other embodiments, polycondensation reaction and polymer formation step can be performed under atmospheric pressure. In other embodiments, the polycondensation reaction and polymer formation step can be performed under vacuum.

Another aspect of the present application relates to a process for preparation of a polymer comprising a moiety of formula:

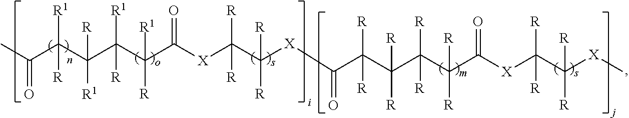

wherein
X is NH or O;
R is independently H or OH;
each R¹ is independently H or OH;
i is 1 to 1,000,000;
j is 1 to 1,000,000;
m is 1 to 30;
n is 1 to 30;
is 1 to 30; and
s is independently 1 to 50;
with the proviso that at least one R¹ is OH,
or a salt thereof.

This process includes:
providing a compound having the structure of formula (II):

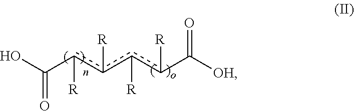

wherein each [symbol] is independently a single or a double bond with no adjacent double bonds, and wherein at least one [symbol] is a double bond;
providing a compound having the structure of formula (III):

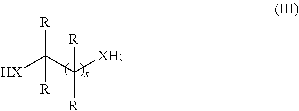

providing a compound having the structure of formula (IV):

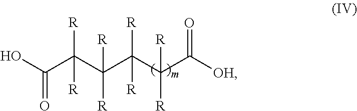

and
reacting the compound of formula (II), the compound of formula (III), and the compound of formula (IV) under conditions effective to produce the polymer.

In one embodiment, the step of reacting the compound of formula (II), the compound of formula (III), and the compound of formula (IV) comprises:
reacting the compound of formula (II) with the compound of formula (III) to form a salt 1;
reacting the compound of formula (IV) with the compound of formula (III) to form a salt 2; and
reacting the salt 1 with the salt 2 under conditions effective to produce the polymer.

In another embodiment, the step of reacting the salt 1 with the salt 2 comprises heating the salt 1 with the salt 2 under inert atmosphere in a reaction vessel. In one embodiment, the heating process is conducted under pressure. In some embodiments, the reaction vessel is vented at least once during said heating process.

During the process of making a polymer according to the present application, salt 1 and salt 2 can be used in any amount from 1 to 99%. In some embodiments, salt 1 and salt 2 are mixed at the ratio of 5% of salt 1 and 95% of salt 2, 10% of salt 1 and 90% of salt 2, 15% of salt 1 and 85% of salt 2, 20% of salt 1 and 80% of salt 2, 25% of salt 1 and 75% of salt 2, 30% of salt 1 and 70% of salt 2, 35% of salt 1 and 65% of salt 2, 40% of salt 1 and 60% of salt 2, 45% of salt 1 and 55% of salt 2, 50% of salt 1 and 50% of salt 2, 55% of salt 1 and 45% of salt 2, 60% of salt 1 and 40% of salt 2, 65% of salt 1 and 35% of salt 2, 70% of salt 1 and 30% of salt 2, 75% of salt 1 and 25% of salt 2, 80% of salt 1 and 20% of salt 2, 85% of salt 1 and 15% of salt 2, 90% of salt 1 and 10% of salt 2, or 95% of salt 1 and 5% of salt 2.

According to the present application, the compound of formula (II), the compound of formula (III), and the compound of formula (IV) can be reacted in any suitable solvent or without the solvent. This reaction can be performed in water, methanol (MeOH), ethanol (EtOH), isopropanol (i-PrOH), dimethylformamide (DMF), acetone, methyl ethyl ketone (MEK), ethyl acetate, THF, or diethyl ether or other such solvents or in a mixture of such solvents. Preferably, the compound of formula (II), the compound of formula (III), and the compound of formula (IV) are reacted in the presence of water.

According to the present application, the compound of formula (II), the compound of formula (III), and the compound of formula (IV) can be reacted under pressure. For example, compound of formula (II), the compound of formula (III), and the compound of formula (IV) can be reacted under pressure of 10 to 1000 psig, 15 to 1000 psig, 20 to 900 psig, 30 to 800 psig, 40 to 700 psig, 50 to 600 psig, 50 to 500 psig, 60 to 500 psig, 70 to 500 psig, 80 to 500 psig, 90 to 500 psig, 100 to 500 psig, 110 to 500 psig, 120 to 500 psig, 130 to 500 psig, 140 to 500 psig, 150 to 500 psig, 160 to 500 psig, 170 to 500 psig, 180 to 500 psig, 190 to 500 psig, 200 to 500 psig, 210 to 500 psig, 220 to 500 psig, 230 to 500 psig, 240 to 500 psig, 250 to 500 psig, 260 to 500 psig, 270 to 500 psig, 280 to 500 psig, 290 to 500 psig, 300 to 500 psig, 100 to 400 psig, 110 to 400 psig, 120 to 400 psig, 130 to 400 psig, 140 to 400 psig, 150 to 400 psig, 160 to 400 psig, 170 to 400 psig, 180 to 400 psig, 190 to 400 psig, 200 to 400 psig, 210 to 400 psig, 220 to 400 psig, 230 to 400 psig, 240 to 400 psig, 250 to 400 psig, 260 to 400 psig, 270 to 400 psig, 280 to 400 psig, 290 to 400 psig, 300 to 400 psig, 100 to 350 psig, 110 to 350 psig, 120 to 350 psig, 130 to 350 psig, 140 to 350 psig, 150 to 350 psig, 160 to 350 psig, 170 to 350 psig, 180 to 350 psig, 190 to 350 psig, 200 to 350 psig, 210 to 350 psig, 220 to 350 psig, 230 to 350 psig, 240 to 350 psig, 250 to 350 psig, 260 to 350 psig, 270 to 350 psig, 280 to 350 psig, 290 to 350 psig, or 300 to 350 psig.

In some embodiments, the compound of formula (II), the compound of formula (III), and the compound of formula (IV) are reacted under vacuum.

Another aspect of the present application relates to a textile treatment composition comprising the polymer according to the present application. The textile treatment composition includes the polymer according to the present application with one or more optional ingredients.

For example, the following optional ingredients can be added to the fiber treatment composition: one or more surfactants, one or more emulsifiers, an organic acid, a carrier, a thickener, a crease resist resin, an oil soluble colorant, a water soluble colorant, an organic fiber treatment compound, and other additives.

Emulsifiers that can be used in the textile composition include, for example, anionic, cationic, nonionic and amphoteric emulsifiers, protective colloids, and particles that stabilize emulsions. Emulsifiers are preferably used in amounts of 1 to 60 parts by weight, more preferably 2 to 30 parts by weight, all based on 100 parts by weight of the polymer of the present application.

Suitable emulsifiers that can be used include decylaminobetaine; cocoamidosulfobetaine; oleylamidobetaine; cocoimidazoline; cocosulfoimidazoline; cetylimidazoline; 1-hydroxyethyl-2-heptadecenyl-imidazoline; n-cocomorpholine oxide; decyldimethyl-amine oxide; cocoamidodimethylamine oxide; sorbitan tristearate having condensed groups of ethylene oxide; sorbitan trioleate having condensed groups of ethylene oxide; sodium or potassium dodecylsulfate; sodium or potassium stearylsulfate; sodium or potassium dodecylbenzenesulfonate; sodium or potassium stearylsulfonate; triethanolamine salt of dodecylsulfate; trimethyldodecylammonium chloride; trimethylstearylammonium methosulfate; sodium laurate; sodium or potassium myristate, di-n-butyl phosphate, di-n-hexyl phosphate, mono-n-octyl phosphate, di-n-octyl phosphate, mono-2-ethylhexyl phosphate, di-2-ethylhexyl phosphate, mono-i-nonyl phosphate, di-i-nonyl phosphate, mono-n-decyl phosphate, n-octyl n-decyl phosphate, di-n-decyl phosphate, monoisotridecyl phosphate, di-n-nonyl phenyl phosphate, monooleyl phosphate and distearyl phosphate; mono-n-octyl phosphate, di-n-octyl phosphate, mono-n-decyl phosphate, n-octyl n-decyl phosphate, di-n-decyl phosphate, ethoxylated castor oil having 200 ethylene glycol units, ethoxylated castor oil having 40 ethylene glycol units and ethoxylated hydrogenated castor oil having 200 ethylene glycol units, polyoxyethylene (20) sorbitan stearate (Polysorbate 60), Polyoxyethylene (20) sorbitan tristearate (Polysorbate 65), Polyoxyethylene (20) sorbitan oleate (Polysorbate 80), and Polyoxyethylene (20) sorbitan laurate (Polysorbate 20).

Suitable emulsifying protective colloids include, for example, polyvinyl alcohols and also cellulose ethers, such as methylcellulose, hydroxyethylcellulose and carboxymethylcellulose.

Suitable particles for stabilizing emulsions include, for example, partially hydrophobed colloidal silicas.

Suitable carriers that can be used according to the present application include water and organic solvents.

Suitable organic solvents that can be used according to the present application include hydrocarbons such as pentane, n-hexane, hexane isomer mixtures, heptane, octane, naphtha, petroleum ether, benzene, toluene and xylenes; halogenated hydrocarbons such as dichloromethane, trichloromethane, tetrachloromethane, 1,2-dichloroethane and trichloroethylene; alcohols such as methanol, ethanol, n-propanol, isopropanol, n-amyl alcohol and i-amyl alcohol; ketones such as acetone, methyl ethyl ketone, diisopropyl ketone, and methyl isobutyl ketone (MIBK); esters such as ethyl acetate, butyl acetate, propyl propionate, ethyl butyrate and ethyl isobutyrate; ethers such as tetrahydrofuran, diethyl ether, diisopropyl ether and diethylene glycol dimethyl ether; or mixtures thereof.

Organic solvents are preferably used in an amount of 100 to 10,000 parts by weight per 100 parts by weight of the polymer of the present application.

Suitable additives that can be used include, for example, conventional preservatives, dyes/scents, especially preservatives such as methylisothiazolinone, chloromethylisothiazolinone, benzylisothiazolinone, phenoxyethanol, methylparaben, ethylparaben, propylparaben, butylparaben, isobutylparaben, alkali metal benzoates, alkali metal sorbates, iodopropynyl butyl carbamate, benzyl alcohol, and 2-bromo-2-nitropropane-1,3-diol.

When additives are used, the amounts are preferably 0.0005 to 2 parts by weight, based on 100 parts by weight of the polymer according to the present application.

The textile treatment composition can have any suitable form. For example, the composition can be a solution, dispersion, or emulsion.

Useful mixing and homogenizing tools to prepare the compositions of the invention in the form of an aqueous emulsion include any conventional emulsifying devices, for example high-speed stirrers, dissolver disks, rotor-stator homogenizers, ultrasonic homogenizers, and high-pressure homogenizers in various designs. When large particles are desired, slow-speed stirrers are also suitable.

Another aspect of the present application relates to a method for preparing a textile treatment composition. The method comprises combining the polymer according to the present application with any optional ingredients. Typically, the polymer according to the present application and any optional ingredients are combined by a process selected from the group consisting of dissolving, dispersing, and emulsifying.

Another aspect of the present application relates to a method for impregnating textiles, comprising impregnating a textile with a composition comprising the polymer according to the present application. The method comprises applying the textile treatment composition to the textile and thereafter removing the carrier, if any.

The textile treatment composition can have any suitable form. For example, the composition can be applied to the textile neat. However, the textile treatment composition can be a solution, dispersion, or emulsion.

The textile treatment composition can be applied to the textile by any convenient method. For example, the composition can be applied by padding, dipping, spraying, exhausting, spreading, casting, rolling, printing, or foam application.

When the textile treatment composition comprises more than one solution, dispersion, or emulsion; the solutions, dispersions, and emulsions can be applied simultaneously or sequentially to the textiles. After the textile treatment composition is applied to the fabric, it can be dried by heating.

The textile treatment composition can be applied to the textiles during making the textiles or later, such as during laundering the textiles. After application, the carrier can be removed from the textile treatment composition by, for example, drying at ambient or elevated temperature. The treated textiles can be dried at temperatures of 10° C. to 250° C., of 25° C. to 200° C., or of 80° C. to 180° C.

The amount of textile treatment composition applied to the textile is typically sufficient to provide 0.1 to 15 wt % of the weight of the polymer on the textile, based on the dry weight of the textile. Preferably, the weight of the polymer on the textile is 0.2 to 1 wt % based on the dry weight of the textile.

Examples of textiles are natural or synthetically produced fibers, yarns, webs, matts, skeins, threads, filaments, tows, woven fabrics, knotted or knitted materials, nonwoven materials, and others. The textiles may be present as individual fibers, fiber bundles, fiberfill fibers, yarns, carpets, fabric webs, or garments or parts of garments.

The textiles that can be treated with the textile treatment composition described above include cotton, wool, linen, rayon, hemp, silk, copolymers of vinyl acetate, polypropylene, polyethylene, polyester, polyurethane, polyamide, aramid, polyimide, polyacrylate, polyacrylonitrile, polylactide, polyvinyl chloride, glass fibers, ceramic fibers, cellulose and combinations and blends thereof.

The above disclosure is general. A more specific description is provided below in the following examples. The examples are described solely for the purpose of illustration and are not intended to limit the scope of the present application. Changes in form and substitution of equivalents are contemplated as circumstances suggest or render expedient. Although specific terms have been employed herein, such terms are intended in a descriptive sense and not for purposes of limitation.

### EXAMPLES

The following Examples are presented to illustrate various aspects of the present application, but are not intended to limit the scope of the claimed application.

### Example 1—Materials

Adipic acid (AA) and hexamethylenediamine (HMDA) [98% purity], were purchased form Sigma Aldrich. trans-3-Hexenedioic acid (t3HDA) [>98% purity] was purchased from TCI America.

### Example 2—Monomer Salt Preparation

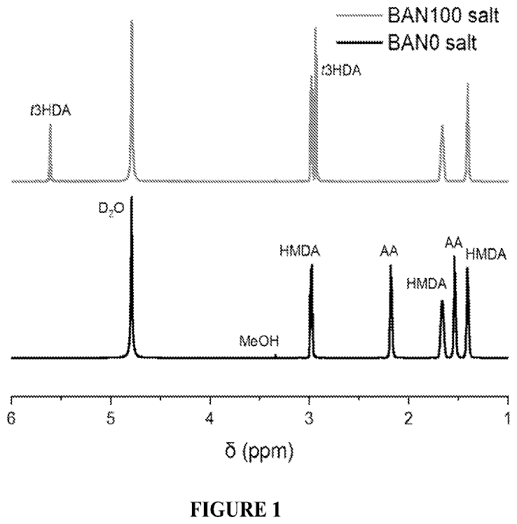

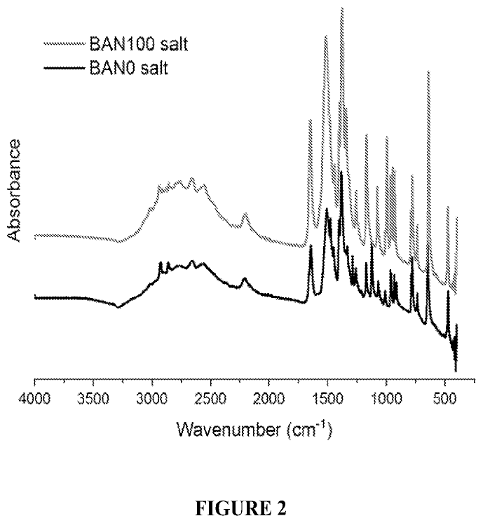

Prior to polymerization, t3HDA, AA, and HMDA were prepared into HMDA-t3HDA and HMDA-AA salts to ensure proper end group stoichiometry. HMDA-t3HDA and HMDA-AA salts were prepared separately instead of producing a HMDA-AA-t3HDA salt in a single process to prevent composition drift due to possible differences in solubility. Salts were prepared by first dissolving AA and t3HDA separately in methanol (CH₃OH). The resulting solutions were then separately mixed with solutions of HMDA in CH₃OH such that the molar ratio of carboxylic acid units to amine units was 1:1. Each combined solution was then heated in a round bottom flask at 60° C. for at least 30 min. The precipitated salts were subsequently filtered, washed with CH₃OH, and left to dry in a fume hood. After drying, these salts were combined such that a target mole percentage of x diacid monomers were t3HDA. The composition of the salts were confirmed using 1H NMR and FT-IR, for example as shown in FIGS. 1 and 2, respectively.

### Example 3—Polymerization

BANs were prepared using a bulk polycondensation method. HMDA-AA-t3HDA salts with different amounts of t3HDA were polymerized in an autoclave reactor equipped with a heating jacket and an external temperature controller. The salt was mixed with 20-25 v/w % water prior to the reaction to facilitate adequate mixing. The reactor was then purged with nitrogen and pressurized to 150 psig to prevent oxidation and thermal decomposition. The first stage of the polymerization reaction consisted of stirring the wet salt at 150 rpm while the reactor was heated using a fixed set point of 265° C. for 2 hours such that it reached an internal pressure of roughly 300 psig. Previous calibration showed that this set point yielded an internal temperature of roughly 230° C. During the second stage of the polymerization, the reactor was then vented to atmospheric pressure and the polymer melt was stirred at 400 rpm while the reactor was heated at a set point of 300° C. for 2 hours. Previous calibration showed that this set point yielded an internal temperature of roughly 275° C. After the second stage, the reactor was cooled and the solid polymer was collected. Two batches of each BAN were made to produce sufficient sample for characterization. BANs were ground into a powder using a Retsch CryoMill, like batches were uniformly mixed, and BAN powders were dried at 80° C. under static vacuum for 48 hours prior to processing and analysis. When appropriate, the abbreviation BANx is used to indicate a BAN sample where x mole percent of the diacid units are a novel monomer. For example, BAN0 has 0% t3HDA and is equivalent to unmodified Nylon 6,6.

### Example 4—Gel Permeation Chromatography

The molecular weight distribution of each BAN was characterized via gel permeation chromatography (GPC). GPC was carried out on BAN samples using a Tosoh Ecosec HLC-8320GPC equipped with a Tosoh TSKgel SuperH6000 150×6.0 mm column in series with two Agilent PL HFIPgel 250×4.6 mm columns along with RI and UV detectors. The solvent 1,1,1,3,3,3-hexafluoroisopropanol (HFIP) was used as the eluent, and sodium trifluoroacetate with a concentration of 0.02 mol/L HFIP was used as an additive to prevent sample aggregation. Each sample had an injection volume of 10 μL and was analyzed at 45° C. under a 0.3 mL/min flow rate. The molecular weight of each BAN was calculated based on Agilent PMMA standards. The molecular weight in terms of PMMA was corrected to be in terms of Nylon 6,6 by comparing it to Nylon 6,6 standards purchased from American Polymer Standards (Table 1). The molecular weight of each Nylon 6,6 standard was determined in terms of PMMA, plotted against the manufacturer's reported value, and curve-fit to develop a relationship between the PMMA-based and Nylon 6,6-based molecular weight. Using this curve-fitting function, the molecular weight of BANs were determined in terms of Nylon 6,6.

TABLE 1
Molecular Weights of Nylon 6,6 Standards
From American Polymer Standards

| | |
|---|---|
| Reported^{a} | Calculated^{b} |

| Mₙ^{c} (kDa) | M_{w}^{d} (kDa) | Mₙ^{c} (kDa) | M_{w}^{d} (kDa) |
|---|---|---|---|
| 14.8 | 32.1 | 22.1 | 51.5 |
| 15.0 | 33.1 | 22.9 | 55.5 |
| 17.4 | 40.5 | 32.3 | 81.6 |
| 20.8 | 46.2 | 38.4 | 106.3 |

^{a}Values reported by the manufacturer.
^{b}Values calculated using a PMMA calibration curve.
^{c}Number average molecular weight (Mₙ).
^{d}Weight average molecular weight (M_{w}).

Reported molecular weights were plotted against the calculated values and curve fit to cubic functions. The equations obtained were

$${N}_{n} = ( 1.164 \times 1 {0}^{- 9} ) {P}_{n}^{3} - ( 8.942 \times 1 {0}^{- 5} ) {P}_{n}^{2} + 2.507 {P}_{n} - 9481 \\ and \qquad ( Eq . 1 )$$

$${N}_{w} = ( - 3.928 \times 1 {0}^{- 11} ) {P}_{w}^{3} + ( 8.521 \times 1 {0}^{- 6} ) {P}_{w}^{2} - 0.3244 {P}_{w} - 31570 \qquad ( Eq . 2 )$$

where Nₙ is the number average molecular weight in terms of Nylon 6,6, Pₙ is the number average molecular weight in terms of PMMA, N_{w} is the weight average molecular weight in terms of Nylon 6,6, and P_{w} is the weight average molecular weight in terms of PMMA. Sample molecular weights were first calculated in terms of PMMA using a PMMA calibration curve. The resulting molecular weights were then used as arguments in these equations to determine sample molecular weights in terms of Nylon 6,6.

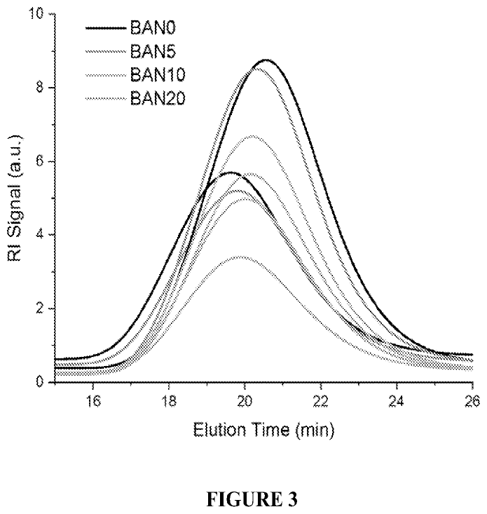

The GPC chromatograms obtained for independent batches of each BAN sample are shown in FIG. 3. The results indicate that the polymerization process was reproducible. Based on the chromatograms, all samples have similar peak molecular weights and peak widths.

Molecular weight calculations based on PMMA and Nylon 6,6 standards further corroborate these results. The molecular weights of all BANs were within 1 kDa of each other. Furthermore, the number average molecular weight of each BAN was greater than 15 kg/mol and the dispersity was approximately 2, indicating that the BANs produced were of commercial quality. Commercial quality Nylon 6,6 typically has a number average molecular weight between 15 and 30 kg/mol. For comparison, Nylon 6,6 purchased from Sigma Aldrich (Commercial PA66) was also analyzed. It is well known that the molecular weight of polymers has a significant effect on their properties up to a limiting molecular weight, so it is necessary to ensure that molecular weight is sufficiently high for unambiguous comparisons to be made (Fox et al., “Influence of Molecular Weight and Degree of Crosslinking on the Specific Volume and Glass Temperature of Polymers,” J. Polym. Sci. 15 (80): 371-390 (1955); Nunes et al., “Influence of Molecular Weight and Molecular Weight Distribution on Mechanical Properties of Polymers,” Polym. Eng. Sci. 22 (4): 205-228 (1982), which are hereby incorporated by reference in their entirety). While BAN molecular weight is lower than that of Commercial PA66, the results discussed below indicate that the molecular weight is sufficiently high for thermal and mechanical properties to not change with further increase. To rationalize how t3HDA loading influences polymer properties, the chemical structure of BAN was determined.

### Example 5—Nuclear Magnetic Resonance Spectroscopy

A Bruker Avance III 600 nuclear magnetic resonance spectrometer was used to collect proton nuclear magnetic resonance (¹H NMR) spectra of each BAN. To dissolve BANs, a solution of two parts trifluoroacetic anhydride and one part deuterated chloroform was used. Tetramethyl silane (TMS), included at 1 v/v % in the deuterated chloroform, was used as a reference. The spectrum of BAN0 was subtracted from the other spectra to isolate new peaks attributable to t3HDA loading. To quantify the inclusion of novel monomer into the polymer, the ratio of novel monomer to the total number of repeat units was calculated using proton integrations:

$${r}_{obs} = \frac{{I}_{1 H}}{( {I}_{tot} / 22 )} \qquad ( Eq . 3 )$$

where r_{obs} is the observed ratio, I_{1H} is the integration of a single proton attributed to the novel monomer, Iₜₒₜ is the total integration of all polyamide signals, and 22 is number of protons in a repeat unit. To assess novel monomer inclusion, the resulting ratios were compared to expected values based on the degree of t3HDA loading:

$${r}_{exp} = {X}_{t 3 HDA} \qquad ( Eq . 4 )$$

where rₑₓₚ is the expected proton ratio for complete incorporation and X_{t3HDA} is the mol fraction of t3HDA loaded.

A Bruker NEO 400 nuclear magnetic resonance spectrometer was used to collect heteronuclear single quantum coherence (HSQC) spectra of each BAN. Samples were dissolved in the same solvent system used for 1H NMR. Samples were heated to 40° C. and spun at 20 Hz to reduce sample viscosity and minimize convection. The number of scans was 256. Using BAN0 as a reference, novel cross peaks were used to identify CH and CH₂ groups.

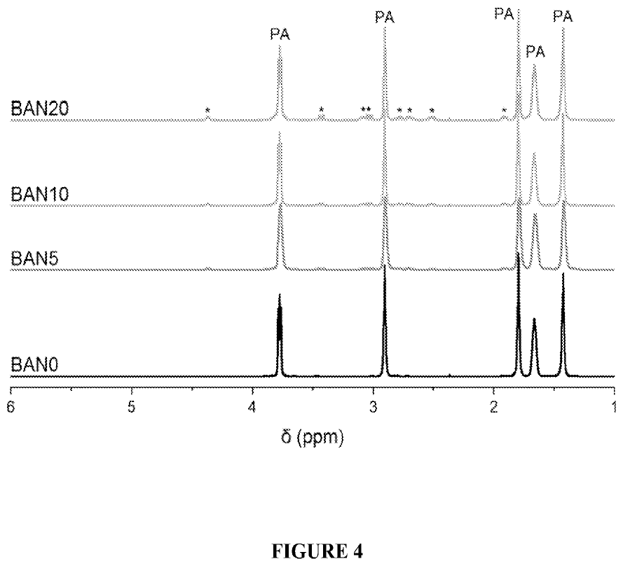

The chemical structure of BAN was analyzed using ¹H NMR and HSQC. BAN spectra are shown in FIG. 4. The peaks labeled PA are characteristic of Nylon 6,6 and correspond to the methylene protons of condensed adipic acid and hexamethylene diamine. As the t3HDA loading increased, 8 distinct signals appeared and gradually increased in intensity. These novel peaks are marked with * in FIG. 4. The chemical shifts of these peaks were inconsistent with the 2 alkene and methylene signals that would be expected of t3HDA loading. Furthermore, no signal was observed in the 5-6 ppm region characteristic of disubstituted, unconjugated alkenes. This suggests t3HDA reacted during the harsh reaction conditions of the polycondensation process.

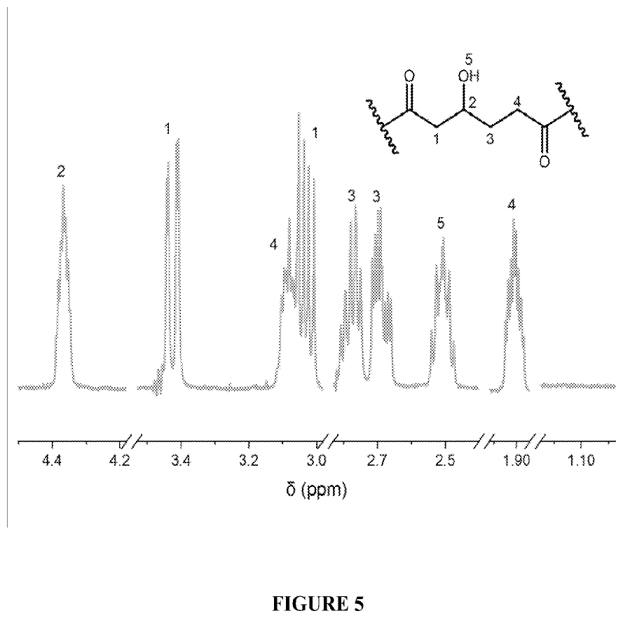

To identify the new repeat unit produced during the reaction, the observed number of new signals, chemical shifts, relative integrations, and couplings were all considered. New signals attributable to the novel monomer were isolated by subtracting out the BAN0 spectrum. This removed all characteristic Nylon 6,6 signals, including end group signals which overlapped with the signals of interest. A representative fully analyzed spectrum of BAN20 is shown in FIG. 5 along with the proposed structure. Peak 2 has a 4.37 ppm chemical shift, suggesting that it is geminal to an electronegative moiety such as a hydroxyl group. Integration revealed that each novel peak had a relative integration of 1, implying that each peak corresponds to a single proton. Analyzing J-couplings showed that the number of coupling partners for each proton is largely consistent with the proposed structure, but complex multiplet patterns precluded a complete analysis. Furthermore, clear second order coupling was observed for peak pairs 1 and 4, suggesting they correspond to geminal hydrogens. J-couplings between peak 2 and peak pair 1 are notably consistent with a hexagonal chair conformation, which is likely favored due to hydrogen bonding between the proposed hydroxyl group and the proximal carbonyl group.

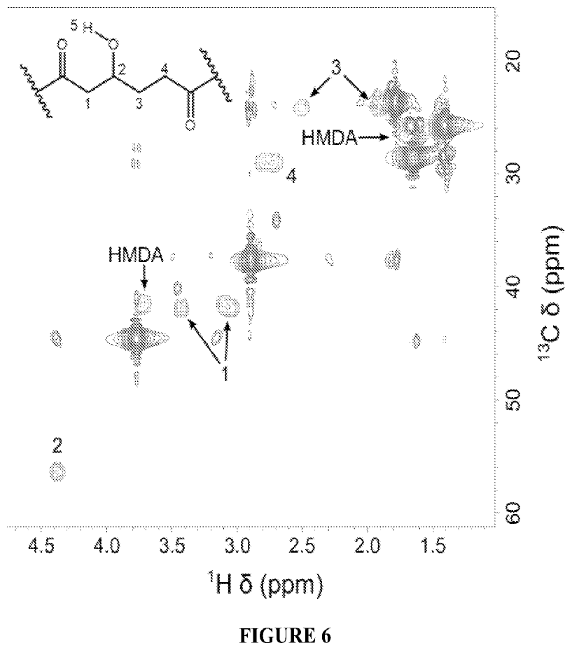

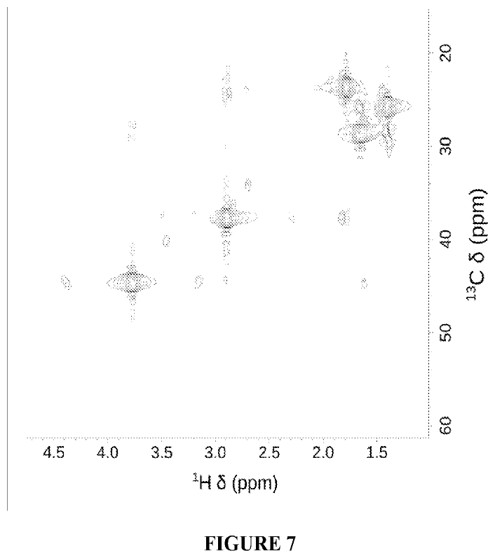

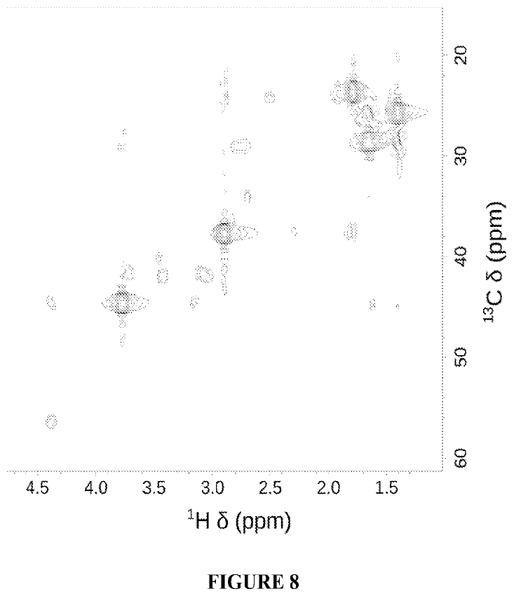

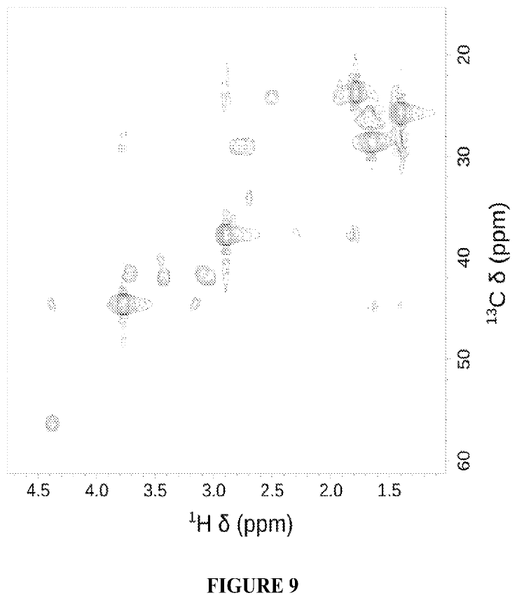

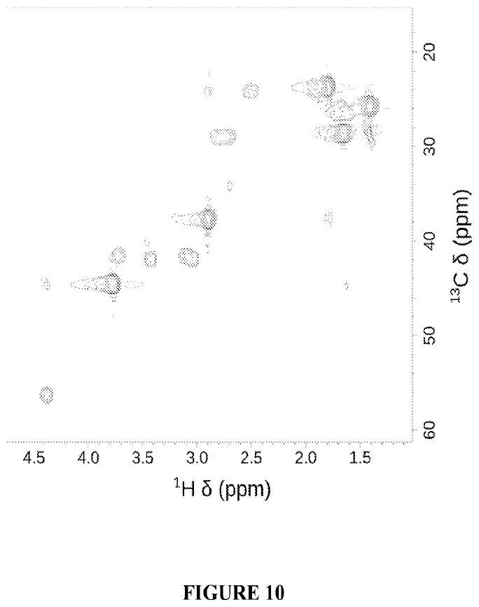

HSQC was used to corroborate the structural conclusions drawn from 1H NMR. A representative overlay of BAN0 and BAN10 HSQC spectra is shown in FIG. 6. Additional HSQC spectra showing phases are provided in FIGS. 7-10. Novel 1H NMR peaks were found to correspond to novel ¹³C peaks, though in some cases these peaks overlapped with other, stronger peaks and could not be observed. Cross peaks 1, 3, and 4 were found to correspond to methylene groups, while cross peak 2 was found to correspond to a methine group. Notably, peak 5 had no corresponding cross peak in the HSQC spectra, showing that, as anticipated, it is not bound to a carbon atom. The ¹³C shift of cross peak 2 is within the characteristic range of COH carbons, further corroborating in-situ hydration and the proposed structure. While two additional cross peaks were observed that do not correspond to 3HHDA, these peaks are attributable to HMDA proximal to 3HHDA in the polymer chain.

¹H NMR and HSQC data support the conclusion that t3HDA is hydrated to 3HHDA during the polymerization process. The addition of water as a mass transfer promoter as well as the high-temperature and high-pressure conditions are believed to drive the hydration reaction. The observations that no new signals were produced other than those of 3HHDA and that all samples were solubilized in HFIP without difficulty suggest that any branching or crosslinking due to esterification reactions between the 3HHDA hydroxyl group and other diacids is minimal, if present at all. The continual production of water during the condensation reaction and ready hydrolysis of esters when exposed to pressurized steam (Mohd-Adnan et al., “Evaluation of Kinetics Parameters for Poly(l-Lactic Acid) Hydrolysis under High-Pressure Steam,” Polym. Degrad. Stab. 93 (6): 1053-1058 (2008), which is hereby incorporated by reference in its entirety) likely prevents the formation of branched or crosslinked products. Although it might be predicted that any hydroxyl group would react with the trifluoroacetic anhydride solvent, reactions between sterically hindered alcohols and anhydrides often require catalysts for the reaction to proceed (Höfle et al., “4-Dialkylaminopyridines as Highly Active Acylation Catalysts. [New Synthetic Method (25)],” Angew. Chem. Int. Ed. Engl. 17 (8): 569-583 (1978); Orita et al., “Highly Powerful and Practical Acylation of Alcohols with Acid Anhydride Catalyzed by Bi(OTf)₃,” J. Org. Chem. 66 (26): 8926-8934 (2001); Procopiou et al., “An Extremely Powerful Acylation Reaction of Alcohols with Acid Anhydrides Catalyzed by Trimethylsilyl Trifluoromethanesulfonate,” J. Org. Chem. 63 (7): 2342-2347 (1998), which are hereby incorporated by reference in their entirety). Despite the revelation of a change in structure during the polymerization reaction, t3HDA will continue to be identified as the loaded monomer for simplicity. Reference will be made to 3HHDA when appropriate.

To substantiate the complete incorporation of t3HDA into the polymer, 1H NMR integration ratios were examined. Excellent agreement was observed between experimental and expected results, which deviated by less than 10%. Considering the relatively small signal-to-noise ratio of the novel signals, the possible exacerbation of noise due to the spectral subtraction process, and the presence of both positive and negative deviations which is characteristic of random error, it was concluded that t3HDA was fully incorporated into the polymer. Full inclusion would be expected to influence crystallization behavior, so the influence of 3HDA loading on crystal structure was elucidated.

### Example 6—Wide-Angle X-Ray Scattering (WAXS)

Temperature-dependent wide-angle X-ray scattering (WAXS) measurements were performed using a XENOCS Xeuss 2.0 SWAXS system with monochromatized light of wavelength λ=0.7107 Å from Mo Kα radiation. Data was collected using a silver behenate-calibrated Pilatus 1M detector at a sample-to-detector distance of 33.97 cm. The corresponding scattering vector (q) window for this setup was 0.1-3.5 Å. Annealed powdered samples (Example 8) were sealed in aluminum hermetic pans and fixed to a temperature controlled Linkam THMS600 stage equipped with an LNP95 liquid nitrogen cooling pump. Data was acquired in 10, 15, or 20° C. intervals from room temperature up to within 10° C. of the melting point determined via differential scanning calorimetry. Both heating and cooling sweep data were collected to observe potential hysteresis. Each sample was equilibrated at the desired temperature for 10 min followed by a 10 min acquisition. The percent crystallinities of annealed samples were calculated by integrating the (100), (010/11), and (002) peaks and normalizing them to the total reflection integral. Prior to integration, diffractograms were scaled and the aluminum pan signal was subtracted. Integration was facilitated by fitting the reflection signal to four gaussians and a quadratic baseline. All diffractograms were smoothed using a 5-point adjacent average smoothing protocol to improve clarity.

### Example 7—Thermal Properties

Thermal studies were performed using thermogravimetric analysis (TGA), differential scanning calorimetry (DSC), and dynamic mechanical analysis (DMA). TGA measurements were carried out using a NETZSCH STA model STA 449 F1 Jupiter thermogravimetric analyzer. Each TGA sample weighing 3-5 mg was analyzed in an alumina crucible pan from 80 to 700° C. with a heating rate of 10° C./min under nitrogen atmosphere with a flow rate of 10 mL/min. DSC was conducted on polymer powder sealed in hermetic aluminum pans using a TA Instruments DSC. A typical DSC temperature program consisted of cycling the sample over an appropriate temperature range to observe all thermal transitions at a heating/cooling rate of 10° C./min under nitrogen atmosphere with a flow rate of 50 mL/min. Samples were cycled through heating and cooling twice to establish a consistent thermal history prior to cycling a third time for analysis.

DMA was performed using a TA instrument ARES-G2 rheometer with a 3-point bending fixture under nitrogen gas flow to prevent thermal degradation. All samples were injection molded into 64×12.7×3.2 mm Izod bars using a HAAKE MiniJet Pro and annealed at approximately 200° C. for 48 hours under dynamic vacuum. Samples were analyzed from −30 to the 175° C. at a heating rate of 5° C./min, a flexural strain of 0.05%, and a frequency of 1 Hz to determine the glass transition temperature, storage modulus at 30° C., and loss modulus at 30° C.

### Example 8—Mechanical Properties

The mechanical properties of BANs were determined using tensile and flexural tests. Mechanical test specimens were prepared using a HAAKE MiniJet Pro for injection molding. Prior to molding, specimens were powdered and dried (Example 3) to minimize hydrolytic degradation. After molding, specimens were annealed at approximately 200° C. under dynamic vacuum for 48 hours to ensure all samples had a common thermal history. Injection molded samples were then stored in a desiccator and/or parafilm sealed containers to minimize ambient moisture absorption between tests. Tensile test specimens were prepared according to standard ISO 527-2 1BB. Tensile properties were measured using a 3369 series Instron Universal Testing Machine with a 10 mm/min extension rate. Multiple tensile bars were tested for statistics, and outliers were excluded to obtain data sets of 7 to 10 specimens per sample. Specimens were excluded as outliers if they failed prior yield, shortly after yield, or after inordinate necking. Flexural test specimens were molded into 64×12.7×3.2 mm Izod bars. Flexural tests were carried out in accordance with the ASTM D790 standard using a 3369 series Instron Universal Testing Machine equipped with a 3-point bend fixture. Briefly, 3 mm thick samples were subject to a 0.01 mm/mm/min strain rate using a support span of 50 mm.

### Example 9—Moisture Absorption

Moisture absorption measurements were carried out at room temperature (25° C.) on unannealed 64×12.7×3.2 mm Izod bars. Triplicate specimens of each sample were analyzed for statistics. All specimens were dried at 80° C. for 48 hours under static vacuum prior to being massed on a Mettler Toledo XS105 microbalance with ±0.01 mg precision. Each specimen was then immersed in 18.2 MΩ DI water for 12 days to approximate the equilibrium water absorption. Unabsorbed water was wiped off the surface of the specimens after removing them from the water, then the mass of each specimen was quickly measured using the microbalance.

Moisture absorption was calculated using the following equation

$$A = [ \frac{W - D}{D} ] \times 100 \qquad ( Eq . 5 )$$

where A is the moisture absorption (%), W is the mass of the wet specimen (g), and D is the mass of the dried specimen (g).

### Example 10—Results and Discussion of Examples 1-9

BANs were synthesized by loading biobased t3HDA into Nylon 6,6 as a co-monomer to assess the influence of co-unit loading on structural, thermal, and mechanical properties. These results are summarized in Tables 2, 3, and 4, respectively.

TABLE 2
BAN Structural Properties with Different t3HDA Loadings

| | Mₙ^{a} (kDa) | Ð^{b} (kDa) | | | Dev^{e} |
|---|---|---|---|---|---|
| Sample | (^{f}A/^{g}B) | (^{f}A/^{g}B) | rₑₓₚ^{c} | r_{obs}^{d} | (%) |
| Commercial | 57.1/—^{h} | 2.14/—^{h} | — | — | — |
| PA66 | | | | | |
| BAN0 | 30.0/17.1 | 1.96/2.01 | — | — | — |
| BAN5 | 29.7/16.7 | 1.97/2.04 | 0.05 | 0.0459 | 8.2 |
| BAN10 | 28.6/16.3 | 1.95/2.04 | 0.10 | 0.1073 | 7.3 |
| BAN20 | 28.2/16.2 | 1.95/2.03 | 0.20 | 0.2132 | 6.6 |

^{a}Number average molecular weight (Mₙ).
^{b}Dispersity (Ð).
^{c}Expected proton ratio (rₑₓₚ).
^{d}Observed proton ratio (r_{obs}).
^{e}Deviation between rₑₓₚ and r_{obs} (Dev).
^{f}Where A is in terms of PMMA.
^{g}Where B is in terms of Nylon 6,6.
^{h}Results are invalid due to extrapolation beyond the calibration limits.

TABLE 3
BAN Thermal Properties with Different t3HDA Loadings

| | T_{g}^{a} | Tₘ^{b} | T_{c}^{c} | ΔH_{c}^{d} | DSC | WAXS | T₅^{g} | Res₅₀₀ ^{h} |
|---|---|---|---|---|---|---|---|---|
| Sample | (° C.) | (° C.) | (° C.) | (J/g) | χ_{c}^{e} (%) | χ_{c}^{f} (%) | (° C.) | (%) |
| Commercial | 79.3 | 260.0 | 233.8 | 47.0 | 30.9 | — | 409.4 | 4.4 |
| PA66 | | | | | | | | |
| BAN0 | 79.3 | 257.1 | 223.9 | 43.6 | 19.3 | 72.2 | 394.2 | 3.8 |
| BAN5 | 78.2 | 253.6 | 219.3 | 42.2 | 18.7 | 71.4 | 393.6 | 6.6 |
| BAN10 | 74.5 | 247.0 | 211.3 | 38.7 | 17.1 | 69.0 | 391.8 | 6.6 |
| BAN20 | 72.3 | 233.4 | 192.1 | 32.1 | 14.2 | 67.2 | 395.0 | 6.9 |

^{a}Glass transition temperature determined using DMA (T_{g}).
^{b}Melting temperature (Tₘ).
^{c}Crystallization temperature (T_{c}).
^{d}Enthalpy of crystallization (ΔH_{c}).
^{e}Percent crystallinity from DSC (DSC χ_{c}).
^{f}Annealed sample percent crystallinity from WAXS (WAXS χ_{c}).
^{g}Decomposition temperature at 5% mass loss (T₅).
^{h}Residual mass at 500° C. (Res₅₀₀).

TABLE 4
BAN Physical Properties with Different t3HDA Loadings

| | E″^{a} | E′^{b} | E^{c} | TS^{d} | TT^{e} | UE^{f} | F^{g} | FS^{h} | H₂O Absⁱ |
|---|---|---|---|---|---|---|---|---|---|
| Sample | (MPa) | (GPa) | (GPa) | (MPa) | (MPa) | (%) | (GPa) | (MPa) | (%) |
| Commercial | 64 | 2.93 | 1.13 ± | 98 ± | 70 ± | 80 ± | 2.8 ± | 127 ± | 3.94 ± |
| PA66 | | | 0.03 | 4 | 17 | 20 | 0.5 | 6 | 0.06 |
| BAN0 | 70 | 2.85 | 1.13 ± | 98 ± | 49 ± | 57 ± | 3.2 ± | 131.2 ± | 3.46 ± |
| | | | 0.03 | 5 | 7 | 8 | 0.1 | 0.6 | 0.09 |
| BAN5 | 71 | 3.08 | 1.14 ± | 99 ± | 44 ± | 51 ± | 3.3 ± | 135 ± | 4.30 ± |
| | | | 0.01 | 3 | 2 | 2 | 0.1 | 1 | 0.04 |
| BAN10 | 92 | 3.15 | 1.23 ± | 105 ± | 52 ± | 56 ± | 3.5 ± | 142 ± | 5.269 ± |
| | | | 0.05 | 5 | 5 | 6 | 0.1 | 1 | 0.007 |
| BAN20 | 74 | 3.43 | 1.20 ± | 102 ± | 49 ± | 59 ± | 3.6 ± | 148 ± | 8.8 ± |
| | | | 0.03 | 8 | 16 | 18 | 0.1 | 2 | 0.3 |

^{a}Loss modulus at 30° C. (E″).
^{b}Storage modulus at 30° C. (E′).
^{c}Tensile modulus (E).
^{d}Tensile strength (TS).
^{e}Tensile toughness (TT).
^{f}Ultimate elongation (UE).
^{g}Flexural modulus (F).
^{h}Flexural strength (FS).
ⁱMoisture absorption (H₂O Abs).

GPC results showed that BANs were synthesized with similar molecular weights and low dispersity, thus eliminating the influence of molecular weight on polymer properties from consideration. t3HDA was shown to hydrate to 3-hydroxyhexanedioic acid (3HHDA) in situ and to fully incorporate into the polymer backbone using ¹H NMR. Thermal properties, including glass transition temperature (T_{g}), melting temperature (Tₘ), crystallization temperature (T_{c}), and crystallization enthalpy (ΔH_{c}), were found to decrease with increased t3HDA loading. Using DSC and WAXS, percent crystallinity (χ_{c}) was found to decrease as well. Similar absolute χ_{c} reductions were observed regardless of crystal growth via melt cooling (DSC) or annealing (WAXS). Interestingly, the elasticity as measured by the storage modulus (E′) increased with t3HDA at low temperatures before reversing trend at higher temperatures. These observations can be attributed to the 3HHDA hydroxyl group. Said hydroxyl group reduces packing efficiency, thereby increasing the free volume of the amorphous region at elevated temperatures above which the denser hydrogen bonded network disintegrates. Reduced packing efficiency also prevents co-unit inclusion in crystal lamellae, resulting in reduced crystallinity on account of statistical limitations to crystal growth. Mechanical properties testing, however, indicated that χ_{c} reduction was only minor for the loading levels examined. Tensile and flexural testing showed that the t3HDA loading had minor or insignificant effects on mechanical properties. Thermal and mechanical tests were conducted on dry samples, however, and these properties are known to be impacted by moisture absorption. Considering this influence, moisture absorption tests were performed and it was found that t3HDA loading increases moisture absorption. This observation can be easily explained by the hydroxyl group of 3HHDA, which is not only hydrophilic but also reduces crystallinity via packing disruption. The enhanced hydrophilicity of BAN could make it well suited for applications that require high levels of conditioning. Nylons are typically conditioned to enhance toughness, yield strain, and elongation at break. It is conceivable that BANs could be used for performance athletic fabrics, since flexibility and moisture management are highly desirable properties in this market. BANs' reduced melting point could also ease processing into fibers by reducing the energy costs associated with melt processing.

### Crystalline Structure Determination

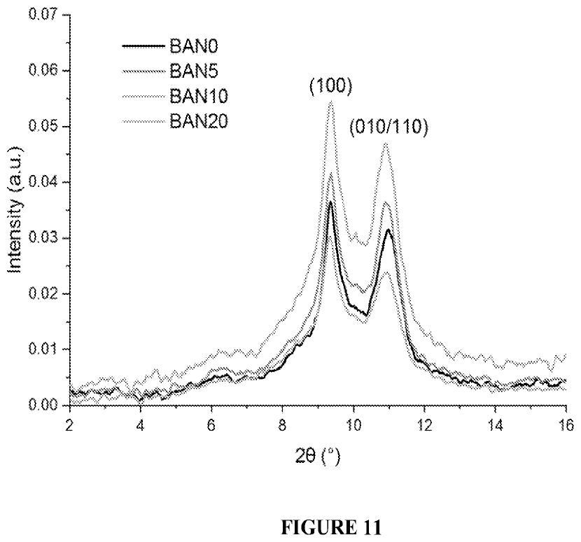

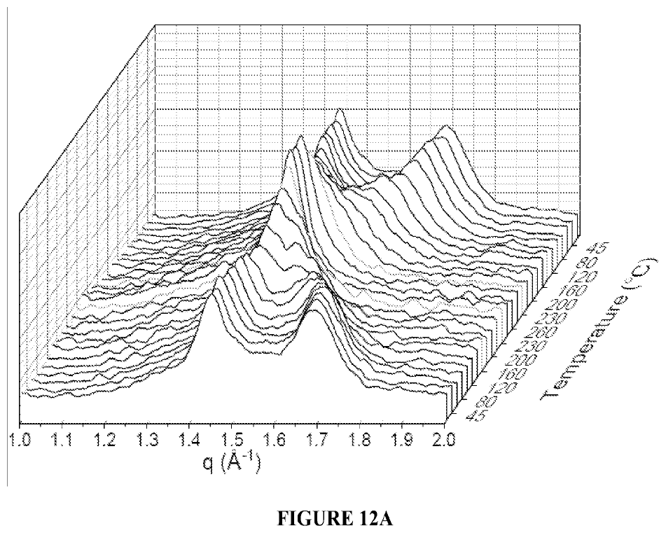

To evaluate the effects of co-monomer loading on crystallization and crystalline structure, temperature dependent WAXS experiments were conducted. Room temperature (25° C.) WAXS patterns are shown in FIG. 11. Two peaks characteristic of Nylon 6,6 are clearly observed at 20 angles of approximately 9.3 and 11.0°, corresponding to the (100) and (010/110) doublet reflections of the triclinic α-phase, respectively (Ramesh et al., “Studies on the Crystallization and Melting of Nylon-6,6:1. The Dependence of the Brill Transition on the Crystallization Temperature,” Polymer 35 (12): 2483-2487 (1994); Feldman et al., “The Brill Transition in Transcrystalline Nylon-66,” Macromolecules 39 (13): 4455-4459 (2006), which are hereby incorporated by reference in their entirety). The intrasheet (100) peak is due to scattering within the polymer chains of a single polymer sheet, and the intersheet (010/110) peak is due to scattering between different polymer sheets connected by hydrogen bonds (Feldman et al., “The Brill Transition in Transcrystalline Nylon-66,” Macromolecules 39 (13): 4455-4459 (2006); Murthy et al., “Premelting Crystalline Relaxations and Phase Transitions in Nylon 6 and 6,6,” Macromolecules 24 (11): 3215-3220 (1991); Feldman et al., “Transcrystallinity in Aramid and Carbon Fiber Reinforced Nylon 66: Determining the Lamellar Orientation by Synchrotron X-Ray Micro Diffraction,” Polymer 45 (21): 7239-7245 (2004), which are hereby incorporated by reference in their entirety). The d spacing and relative intensities of the (100) and (010/110) peaks were unaffected by t3HDA loading, suggesting that the co-monomer is completely excluded from the crystal lattice. Complete exclusion of co-monomer units from the crystal lattice has been observed in studies on other semicrystalline polymers as well (Mandelkern, “The Relation Between Structure and Properties of Crystalline Polymers,” Polym. J. 17 (1): 337-350 (1985), which is hereby incorporated by reference in its entirety). In cases where co-units are excluded from the crystal lattice, it is well established that the co-unit loading hinders crystallization by retarding the lamellar structure (Flory, “Thermodynamics of Crystallization in High Polymers II. Simplified Derivation of Melting-Point Relationships,” J. Chem. Phys. 15(9):684-684 (1947); Flory et al., “Crystallization in High Polymers. VII. Heat of Fusion of Poly-(N,N′-Sebacoylpiperazine) and Its Interaction with Diluents,” J. Am. Chem. Soc. 73(6):2532-2538 (1951); Evans et al., “Crystallization in High Polymers. V. Dependence of Melting Temperatures of Polyesters and Polyamides on Composition and Molecular Weight,”. J. Am. Chem. Soc. 72(5):2018-2028 (1950); Flory, “Theory of Crystallization in Copolymers,” Trans. Faraday Soc. 51 (0): 848-857 (1955), which are hereby incorporated by reference in their entirety). However, given sufficient time and provided that the co-monomer loading is low, chain migration above the glass transition temperature enables well-developed crystals to form (Flory, “Thermodynamics of Crystallization in High Polymers II. Simplified Derivation of Melting-Point Relationships,” J. Chem. Phys. 15(9):684-684 (1947); Flory, “Theory of Crystallization in Copolymers,” Trans. Faraday Soc. 51(0):848-857 (1955), which are hereby incorporated by reference in their entirety). Furthermore, co-units are expelled from crystals and accumulate on the crystal surface (Di Lorenzo et al., “Tailoring the Rigid Amorphous Fraction of Isotactic Polybutene-1 by Ethylene Chain Defects,” Polymer 55 (23): 6132-6139 (2014), which is hereby incorporated by reference in its entirety). In the case of t3HDA loading, the thermodynamic preference for crystallization is sufficiently high for the degree of crystallinity to be minimally affected up to 20% loading. χ_{c} decreased monotonically from 72.2% to 67.2% as t3HDA loading increased.

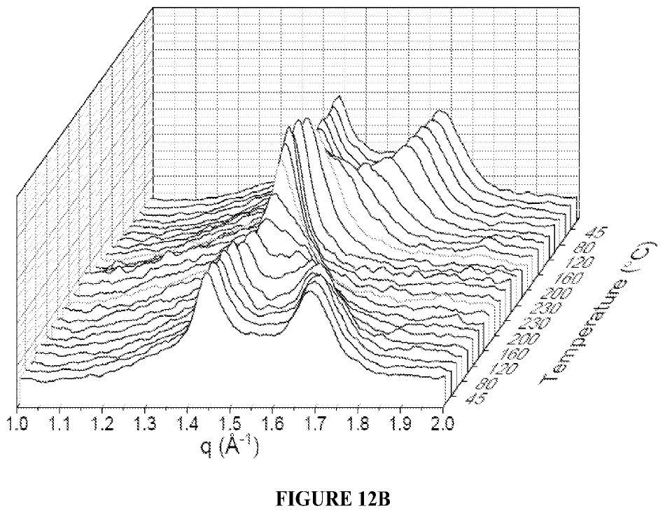

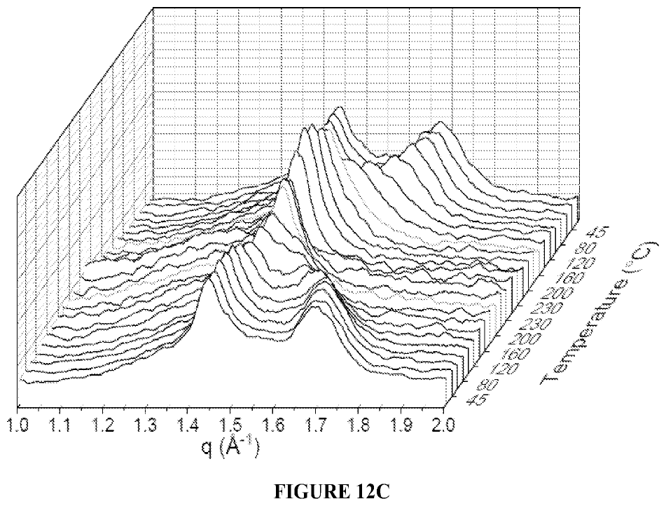

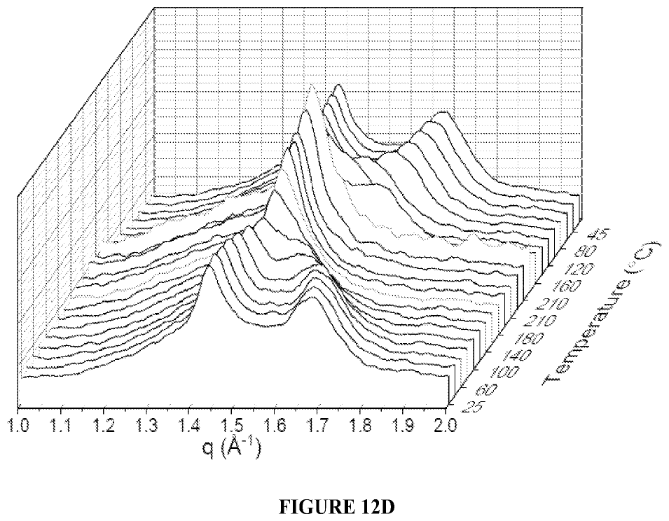

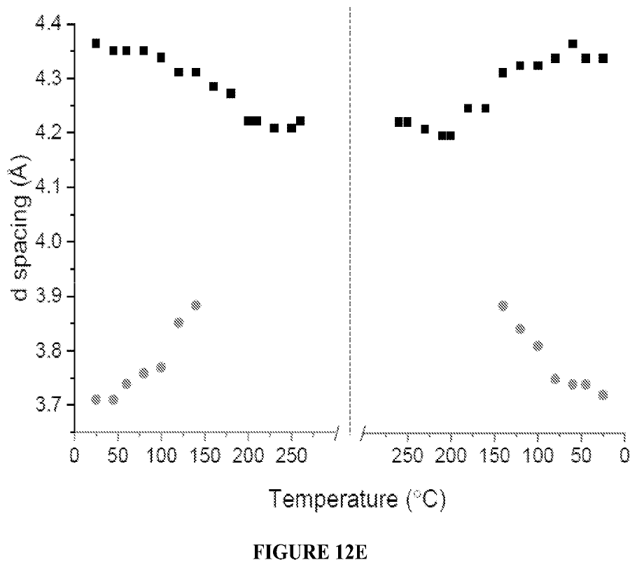

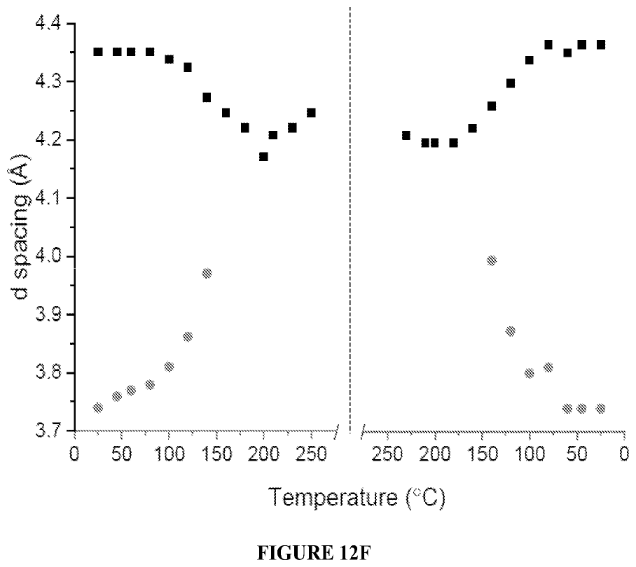

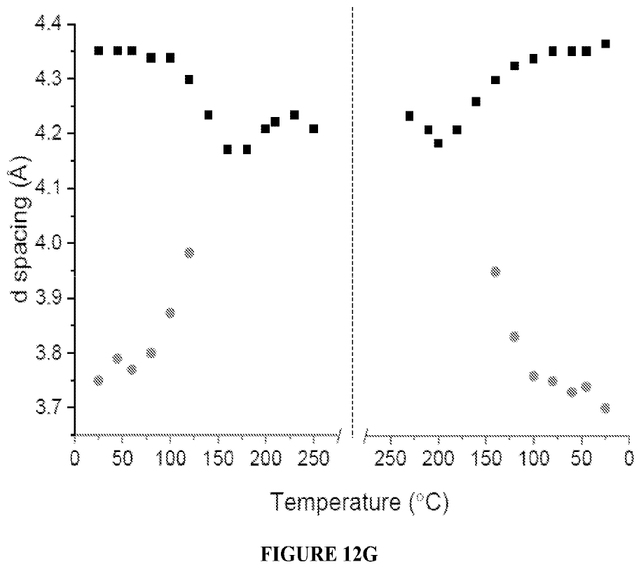

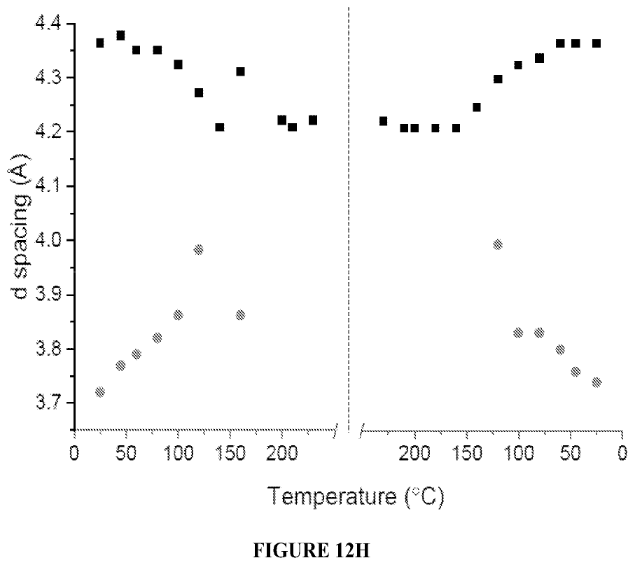

Three dimensional WAXS temperature scans and corresponding d spacing plots are shown in FIGS. 12A-H. Nylon 6,6 and polyamides in general undergo a crystal phase transition, the eponymous Brill transition, at elevated temperatures. During this transition, the interchain (100) peak and the intersheet (010/110) peak shift to higher and lower scattering vectors (q), respectively, until they merge at a specific temperature called the Brill transition temperature (T_{b}) (Feldman et al., “The Brill Transition in Transcrystalline Nylon-66,” Macromolecules 39 (13): 4455-4459 (2006); Murthy et al., “Premelting Crystalline Relaxations and Phase Transitions in Nylon 6 and 6,6,” Macromolecules 24 (11): 3215-3220 (1991); Feldman et al., “Transcrystallinity in Aramid and Carbon Fiber Reinforced Nylon 66: Determining the Lamellar Orientation by Synchrotron X-Ray Micro Diffraction,” Polymer 45 (21): 7239-7245 (2004); Starkweather et al., “Crystalline Transitions in Powders of Nylon 66 Crystallized from Solution,” J. Polym. Sci. Polym. Phys. Ed. 19 (3): 467-477 (1981), which are hereby incorporated by reference in their entirety). The merging of these peaks is attributed to the transition of denser triclinic crystals to a less dense pseudohexagonal or, alternatively, secondary triclinic structure (Feldman et al., “The Brill Transition in Transcrystalline Nylon-66,” Macromolecules 39 (13): 4455-4459 (2006); Starkweather et al., “Crystalline Transitions in Powders of Nylon 66 Crystallized from Solution,” J. Polym. Sci. Polym. Phys. Ed. 19 (3): 467-477 (1981); Murthy et al., “Interactions Between Crystalline and Amorphous Domains in Semicrystalline Polymers: Small-Angle X-Ray Scattering Studies of the Brill Transition in Nylon 6,6,” Macromolecules 32(17):5594-5599 (1999), which are hereby incorporated by reference in their entirety). Though the nature of the Brill transition is still debated (Feldman et al., “The Brill Transition in Transcrystalline Nylon-66,” Macromolecules 39 (13): 4455-4459 (2006), which is hereby incorporated by reference in its entirety), studies have shown that it is highly dependent on processing conditions, crystal structure, and morphology (Ramesh et al., “Studies on the Crystallization and Melting of Nylon-6,6:1. The Dependence of the Brill Transition on the Crystallization Temperature,” Polymer 35 (12): 2483-2487 (1994); Feldman et al., “The Brill Transition in Transcrystalline Nylon-66,” Macromolecules 39 (13): 4455-4459 (2006); Starkweather et al., “Crystalline Transitions in Powders of Nylon 66 Crystallized from Solution,” J. Polym. Sci. Polym. Phys. Ed. 19 (3): 467-477 (1981), which are hereby incorporated by reference in their entirety). The T_{b} of Nylon 6,6 has been observed to vary from 139° C. to 230° C. depending on processing conditions, which is commonly rationalized as the result of variations in crystal perfection and lamellar thickness (Ramesh et al., “Studies on the Crystallization and Melting of Nylon-6,6:1. The Dependence of the Brill Transition on the Crystallization Temperature,” Polymer 35 (12): 2483-2487 (1994); Feldman et al., “The Brill Transition in Transcrystalline Nylon-66,” Macromolecules 39 (13): 4455-4459 (2006), which are hereby incorporated by reference in their entirety). WAXS and SAXS experiments on Nylon 10,10 showed that T_{b} increases with increasing lamellar thickness (Yang et al., “Dependence of the Brill Transition on the Crystal Size of Nylon 10 10,” Macromolecules 34 (17): 5936-5942 (2001), which is hereby incorporated by reference in its entirety). The temperature-dependent WAXS experiments showed that T_{b} decreased monotonically with increasing t3HDA loading. This suggests that t3HDA loading reduces lamellar thickness and that the chains adopt at least a partially random microstructure. Considering all co-monomer units are excluded from crystals, lamellar thickness must be restricted by the statistical number of contiguous crystallizable units in a chain segment (Flory, “Thermodynamics of Crystallization in High Polymers II. Simplified Derivation of Melting-Point Relationships,” J. Chem. Phys. 15(9):684-684 (1947); Flory, “Theory of Crystallization in Copolymers,” Trans. Faraday Soc. 51(0):848-857 (1955), which are hereby incorporated by reference in their entirety). A wholly block microstructure would not significantly restrict the lamellar thickness beyond its natural upper bound, so it must be concluded that BAN microstructure is partially if not wholly random. Notably, T_{b} on cooling was higher for BAN10 and BAN20 than T_{b} on heating. A previous temperature-dependent WAXS study demonstrated hysteresis by varying the isothermal crystallization temperature and attributed the hysteresis to variations in crystal perfection (Ramesh et al., “Studies on the Crystallization and Melting of Nylon-6,6:1. The Dependence of the Brill Transition on the Crystallization Temperature,” Polymer 35 (12): 2483-2487 (1994), which is hereby incorporated by reference in its entirety). The increased T_{b} on cooling can be attributed to lamellar thickening. However, this interpretation cannot fully explain the results observed in this study. Samples were annealed to maximum crystallinity prior to analysis and were not heated above the melting temperature during WAXS. No hysteresis was observed for BAN0 and BAN5, further indicating that no additional lamellar thickening was possible. Postulating that lamellar thickening occurred during the duration of the experiment is untenable and must be dismissed. Hence, an alternative explanation is required.

It was proposed that the amorphous fraction surrounding crystallites influences the onset of crystal phase transitions, which has also been proposed by others (Wolanov et al., “Amorphous and Crystalline Phase Interaction During the Brill Transition in Nylon 66,” Express Polym. Lett. 3 (7): 452-457 (2009), which is hereby incorporated by reference in its entirety). To rationalize this, a brief explanation of polymer crystal morphology is warranted. Extensive evidence has shown that polymer crystals are comprised of lamellar chain stacks wherein the individual lamellae are often separate chains. In this model, crystal basal planes are populated with amorphous chain moieties that are anchored to the crystal via partial-chain inclusion in the lamellae (Flory et al., “Molecular Morphology in Semicrystalline Polymers,” Nature 272 (5650): 226-229 (1978), which is hereby incorporated by reference in its entirety). Such moieties include dangling-ends, which extend into the amorphous bulk; loops, which double back into the crystal and form new lamellae; and tie chains, which span and connect different lamellar stacks (Flory et al., “Molecular Morphology in Semicrystalline Polymers,” Nature 272 (5650): 226-229 (1978); Di Lorenzo et al., “Crystallization-Induced Formation of Rigid Amorphous Fraction,” Polym. Cryst. 1(2):e10023 (2018), which are hereby incorporated by reference in their entirety). These dangling-ends and loops have been termed the rigged amorphous fraction (RAF) by some researchers due to their restricted mobility resulting from anchoring to crystal lamellae. Restricted mobility is said to increase the glass transition temperature (T_{g}) of the RAF (Di Lorenzo et al., “Tailoring the Rigid Amorphous Fraction of Isotactic Polybutene-1 by Ethylene Chain Defects,” Polymer 55 (23): 6132-6139 (2014); Di Lorenzo et al., “Crystallization-Induced Formation of Rigid Amorphous Fraction,” Polym. Cryst. 1(2): e10023 (2018); Di Lorenzo et al., “The Role of the Rigid Amorphous Fraction on Cold Crystallization of Poly(3-Hydroxybutyrate),” Macromolecules 45 (14): 5684-5691 (2012), which are hereby incorporated by reference in their entirety). It has been demonstrated that co-unit loading leads to RAF thickening relative to the crystal thickness when co-units are completely excluded from the crystal lamellae (Mandelkern, “The Relation Between Structure and Properties of Crystalline Polymers,” Polym. J. 17 (1): 337-350 (1985); Di Lorenzo et al., “Tailoring the Rigid Amorphous Fraction of Isotactic Polybutene-1 by Ethylene Chain Defects,” Polymer 55 (23): 6132-6139 (2014); Domszy et al., “The Structure of Copolymer Crystals Formed from Dilute Solution and in Bulk,” J. Polym. Sci. Polym. Phys. Ed. 22 (10): 1727-1744 (1984), which are hereby incorporated by reference in their entirety). This is presumed to be the result of co-unit accumulation in the RAF at the basal plane of the crystal surface and in the remaining mobile amorphous fraction (MAF) (Mandelkern, “The Relation Between Structure and Properties of Crystalline Polymers,” Polym. J. 17 (1): 337-350 (1985); Di Lorenzo et al., “Tailoring the Rigid Amorphous Fraction of Isotactic Polybutene-1 by Ethylene Chain Defects,” Polymer 55 (23): 6132-6139 (2014), which are hereby incorporated by reference in their entirety). It has also been observed that co-monomer loading increases the surface energy at the crystal-RAF interface (Stolte et al., “Spherulite Growth Rate and Fold Surface Free Energy of the Form II Mesophase in Isotactic Polybutene-1 and Random Butene-1/Ethylene Copolymers,” Colloid Polym. Sci. 292 (6): 1479-1485 (2014), which is hereby incorporated by reference in its entirety). Regarding the Brill transition, SAXS experiments have demonstrated simultaneous changes in the RAF (Murthy et al., “Interactions Between Crystalline and Amorphous Domains in Semicrystalline Polymers: Small-Angle X-Ray Scattering Studies of the Brill Transition in Nylon 6,6,” Macromolecules 32 (17): 5594-5599 (1999), which is hereby incorporated by reference in its entirety). Others have noted the correlation between T_{b} and T_{g} in WAXS studies of transcrystalline Nylon 6,6 (Feldman et al., “The Brill Transition in Transcrystalline Nylon-66,” Macromolecules 39 (13): 4455-4459 (2006), which is hereby incorporated by reference in its entirety). Based on the foregoing evidence, it is reasonable to conclude that t3HDA loading reduces the Brill transition temperature on heating by increasing interfacial surface energy between crystals and the RAF. The t3HDA-abundant RAF is believed to adopt a strained conformation while cooling, thus increasing the interfacial energy. This explains why the Brill transition on heating is lower than that on cooling for BANs with higher t3HDA loading. On heating, the RAF transitions from a high-energy strained conformation to a relaxed conformation above the T_{g} of the RAF. On cooling, however, the RAF is initially in an unstrained conformation and the thermodynamic influence of the surface energy is less pronounced. Considering that t3HDA loading and temperature influence the interactions between the amorphous and crystalline phases, thermal properties experiments were conducted.

### Thermal Properties Characterization

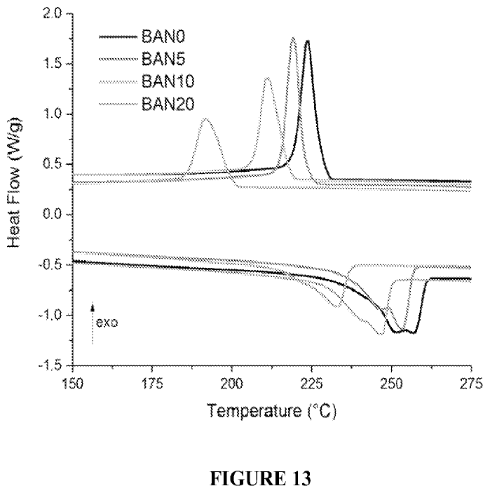

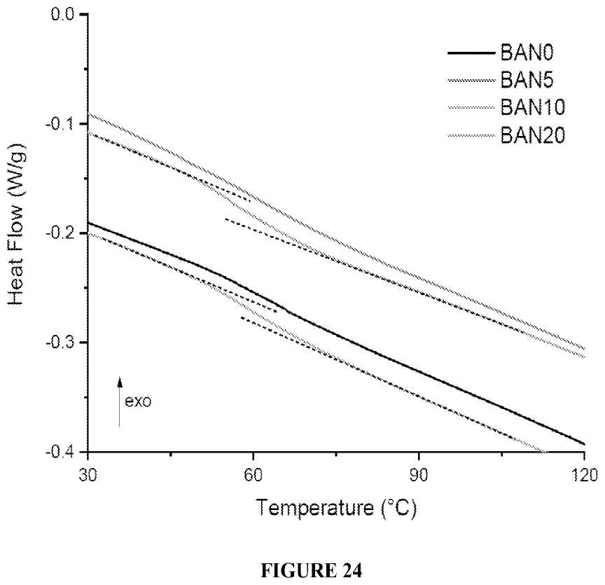

Using DSC, the relationship between crystalline and thermal effects were examined. DSC traces were plotted (FIG. 13) to emphasize the influence of t3HDA loading on peak shape. Tₘ, T_{c}, and χ_{c} were observed to decrease with increased t3HDA loading. This agrees with preliminary screening results discussed previously. Furthermore, Tₘ reduction supports the conclusion from the WAXS study that t3HDA loading reduces lamellar thickness. These results are attributed to the disruptive effect of co-monomer inclusion on crystallization. Co-monomer inclusion in polyamides retards crystallization by disrupting inter-lamellar hydrogen bonding. Upon further t3HDA loading increase, crystal formation becomes critically hindered such that BAN is completely amorphous at greater than 50% t3HDA loading. In addition to reduced intensity, Tₘ and T_{c} peak broadening was also observed with increased t3HDA loading. Melting range broadening has been observed in copolyesters and other copolyamides as well (Flory et al., “Crystallization in High Polymers. VII. Heat of Fusion of Poly-(N,N′-Sebacoylpiperazine) and Its Interaction with Diluents,” J. Am. Chem. Soc. 73 (6): 2532-2538 (1951); Evans et al., “Crystallization in High Polymers. V. Dependence of Melting Temperatures of Polyesters and Polyamides on Composition and Molecular Weight,”. J. Am. Chem. Soc. 72 (5): 2018-2028 (1950), which are hereby incorporated by reference in their entirety). This too can be attributed to reduced lamellar thickness provided the microstructure is random (Flory, “Thermodynamics of Crystallization in High Polymers II. Simplified Derivation of Melting-Point Relationships,” J. Chem. Phys. 15 (9): 684-684 (1947); Flory, “Theory of Crystallization in Copolymers,” Trans. Faraday Soc. 51 (0): 848-857 (1955), which are hereby incorporated by reference in their entirety). For comparison, Commercial PA66 was also analyzed using DSC. In contrast, Tₘ, T_{c}, and χ_{c} were all significantly higher than those of BAN0. This difference was presumed to be the result of small molecule additives that act as crystal nucleation sites. Nucleation sites can significantly increase crystal formation kinetics (Kolstad, “Crystallization Kinetics of Poly(L-Lactide-Co-Meso-Lactide),” J. Appl. Polym. Sci. 62 (7): 1079-1091 (1996), which is hereby incorporated by reference in its entirety). Considering the supporting evidence for t3HDA hydration and full exclusion of 3HHDA from the crystal lattice, a hydrogen bonded network in the amorphous fraction of BAN is anticipated. Such a network could be identified as a second order phase transition in DSC, since the disintegration of this network should cause a sharp change in heat capacity. As the degree of hydrogen bonding in the network increases, the magnitude of the heat capacity change should also increase. The low temperature region of each DSC trace was analyzed (FIG. 24) to examine this possibility. Meeting expectations, a second order phase transition near 60° C. became increasingly pronounced with increased t3HDA loading.

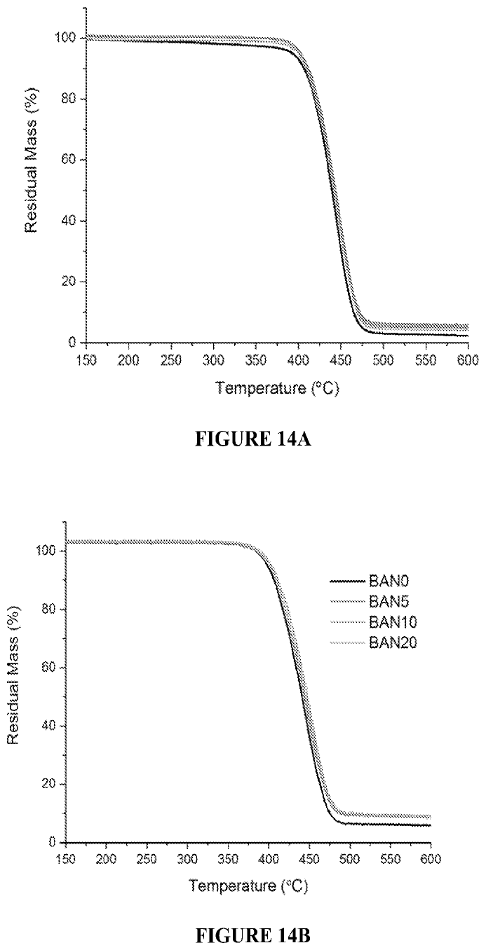

Thermogravimetric analysis was performed on Commercial PA66 and BANs to investigate the influence of t3HDA loading on thermal stability and flame retardancy. Thermogravimetric curves are shown in FIGS. 14A-B. To assess measurement reproducibility, Commercial PA66 was analyzed 5 consecutive times. Thermogravimetric analysis indicated that Commercial PA66 and BANs of all compositions have the same decomposition temperature range between 32° and 500° C. (Nunes et al., “Influence of Molecular Weight and Molecular Weight Distribution on Mechanical Properties of Polymers,” Polym. Eng. Sci. 22 (4): 205-228 (1982), which is hereby incorporated by reference in its entirety). The addition of t3HDA into the Nylon 6,6 system increased the residual mass at 500° C. by more than 50%. This suggested that BAN has some degree of intrinsic flame retardancy since char residue has been shown to correlate well with other flammability metrics when gas phase flame retardancy mechanisms are excluded (Lin et al., “Correlations Between Microscale Combustion calorimetry and Conventional Flammability Tests for Flame Retardant Wire and Cable Compounds,” 56th IWCS Conf.—Proc. Int. Wire Cable Symp. Inc IWCS 2007 (2007), which is hereby incorporated by reference in its entirety). Interestingly, the residual mass was independent of t3HDA loading for loadings between 5% and 20%. No consistent trend in the temperature at 5% mass loss (T₅) was observed when increasing t3HDA loading. For all loading levels examined, effects were minimal and less than 3° C. Notably, T₅ was 15° C. lower for BAN0 compared to Commercial PA66. This can be attributed to the lower molecular weight and hence higher end group density of BAN samples, since thermal degradation in nylons is known to occur in part via chain end mechanisms (Holland et al., “Thermal Degradation of Nylon Polymers,” Polym. Int. 49 (9): 943-948 (2000), which is hereby incorporated by reference in its entirety).

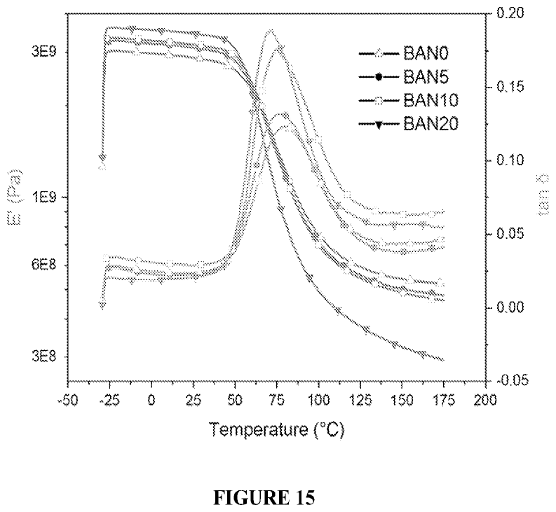

Dynamic mechanical analysis was used to further examine the influence of t3HDA loading on the amorphous phase and its influence on properties relative to the crystalline phase. E′, loss modulus (E″), and T_{g} were determined using this method. The E′, E″, and T_{g} values of Commercial PA66 and BAN0 were found to be nearly identical, as would be expected if BAN0 had sufficiently high molecular weight. E′ and tan δ are plotted as a function of temperature for each BAN composition in FIG. 15. E′ measures a polymer's elasticity, while tan δ describes a polymer's damping ability (Lima et al., “A Simple Strategy toward the Substitution of Styrene by Sobrerol-Based Monomers in Unsaturated Polyester Resins,” Green Chem. 20 (21): 4880-4890 (2018), which is hereby incorporated by reference in its entirety). At lower temperatures, E′ was observed to increase with t3HDA loading, but this trend reversed above 68° C. At lower temperatures, the 3HHDA hydroxyl group increased hydrogen bonding in the MAF and RAF, consequently increasing elasticity as measured by E′. Enhanced amorphous-fraction hydrogen bonding would be expected to decrease amorphous-fraction free volume, thereby increasing the viscous character of the polymer as measured by E″ (Lima et al., “A Simple Strategy toward the Substitution of Styrene by Sobrerol-Based Monomers in Unsaturated Polyester Resins,” Green Chem. 20 (21): 4880-4890 (2018), which is hereby incorporated by reference in its entirety). Matching expectations, E″ was observed to increase with t3HDA loading when measured at 30° C., though only slightly and well within experimental error. It is probable that the reduced packing efficiency afforded by co-monomer loading largely counteracts the attractive force of hydrogen bonding. At higher temperatures, sufficient energy is provided for the amorphous hydrogen bonded network to be broken. The disintegration of said hydrogen bonding network causes elasticity to drop precipitously with increasing temperature, and this phenomenon becomes more pronounced with increased t3HDA loading. Enhanced t3HDA loading is thought to increase the degree of hydrogen bonding in the amorphous region, so this relationship is expected. After the amorphous hydrogen bonding network is broken and polymer chains can move freely, the effects of reduced packing efficiency dominate. The reduced packing efficiency increases free volume, so a decrease in T_{g} is expected. Using the peak of the tan δ curve, T_{g} was found to decrease with increasing t3HDA loading, matching expectations. To further examine the relative influences of the amorphous and crystalline phases on polymer properties, mechanical properties were examined.

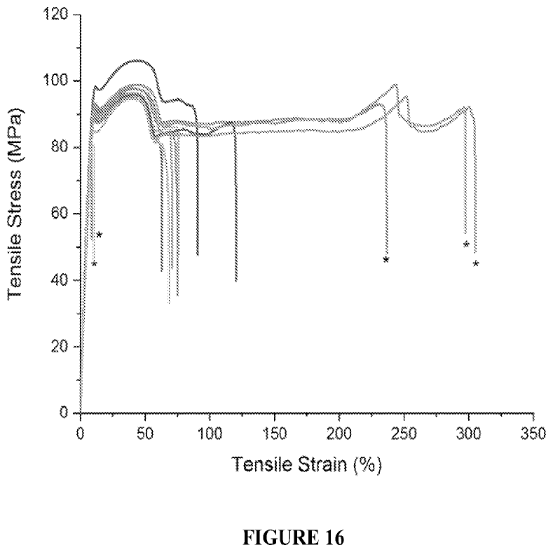

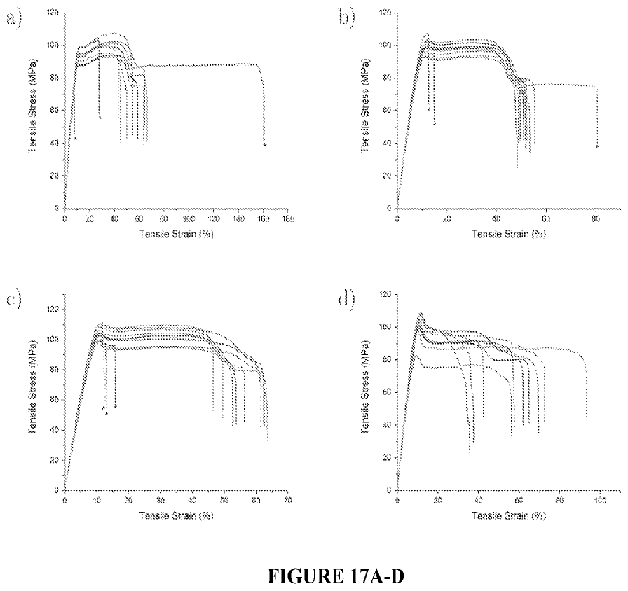

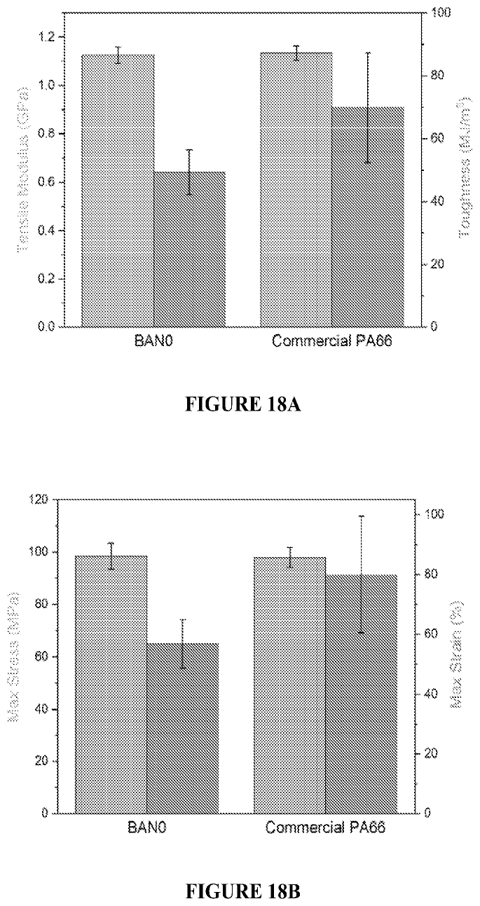

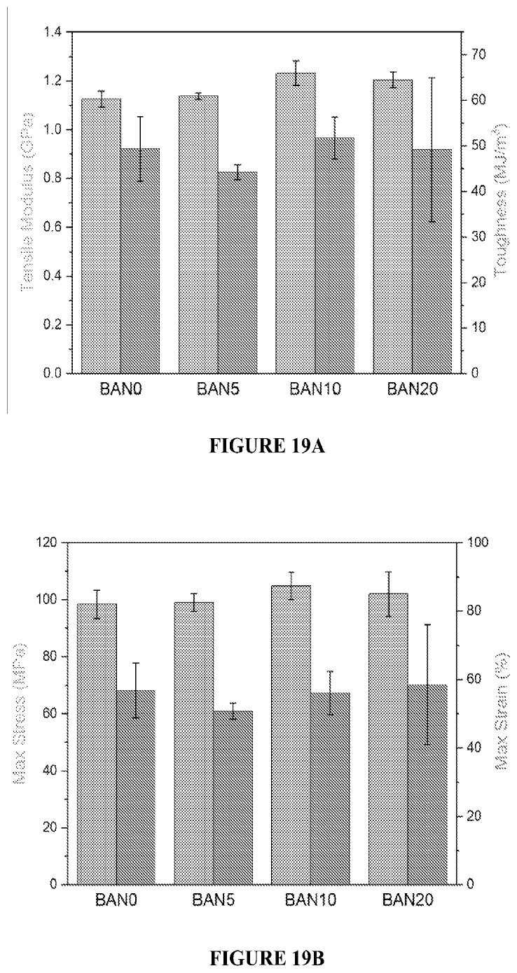

Tensile testing is one of the most common assessments of mechanical properties for engineering thermoplastics such as Nylon 6,6. Using an Instron Universal Testing Machine, the tensile modulus, tensile toughness, maximum stress, and maximum strain of annealed BANs were determined. Tensile stress versus strain plots and bar charts of derived quantities are shown in FIGS. 16, 17A-D, 18A-B, and 19A-B. Notably, strain hardening was increasingly suppressed with t3HDA loading. Strain hardening has been attributed to the recrystallization of chains perpendicular to the strain axis following strain-induced melting (Taniguchi et al., “The Suppression of Strain Induced Crystallization in PET Through Sub Micron TiO₂ Particle Incorporation,” Polymer 45 (19), 6647-6654 (2004), which is hereby incorporated by reference in its entirety). This observation can therefore be attributed to t3HDA's suppressive influence on crystallization, which is affirmed by WAXS and DSC experiments. To verify that the molecular weight was sufficiently high for the mechanical properties to be independent of molecular weight, BAN0 was compared to Commercial PA66. The tensile modulus and maximum strain of BAN0 and Commercial PA66 were identical. While the average toughness and maximum strain of BAN0 and Commercial PA66 deviated by nearly 30%, it should be noted that these differences were statistically insignificant. All tensile properties except for the tensile modulus were observed to be statistically identical across the different BAN compositions studied. The tensile modulus of BAN10 and BAN20 were notably higher than BAN0 and BAN5, however only slightly. The observed mechanical property invariance was likely due to low loading and the similar chemical structure of the co-monomer loaded. As observed in the WAXS experiments, t3HDA loadings less than 20% do not severely impair crystallization. The mechanical contribution of the crystalline domain was therefore similar for the compositions examined. Since 3HHDA, hydrated t3HDA, is structurally similar to adipic acid, it has a minimal effect on the mechanical properties of the amorphous domain that can only be observed in the tensile modulus at higher loadings. The toughness, maximum stress, and maximum strain remain unaffected. The larger tensile moduli of the BANs with higher loadings was likely due to a greater degree of hydrogen bonding afforded by the hydroxyl group of 3HHDA; the RAF, which in general is more rigid than the MAF, likely contributed as well.

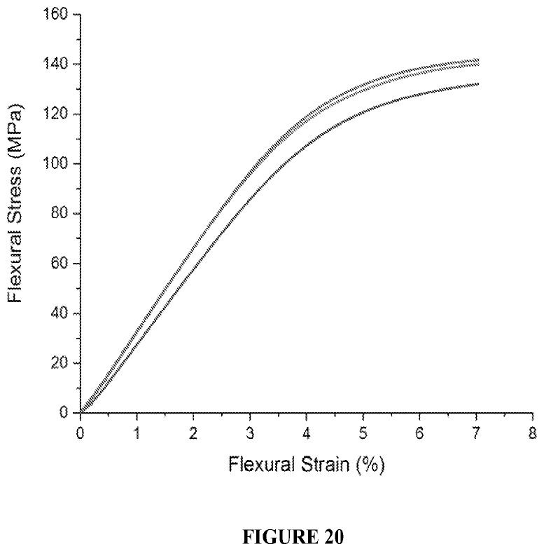

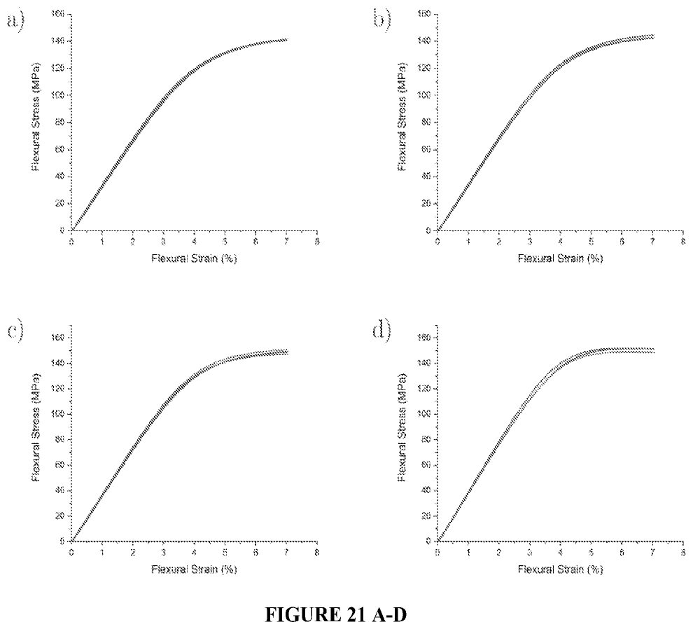

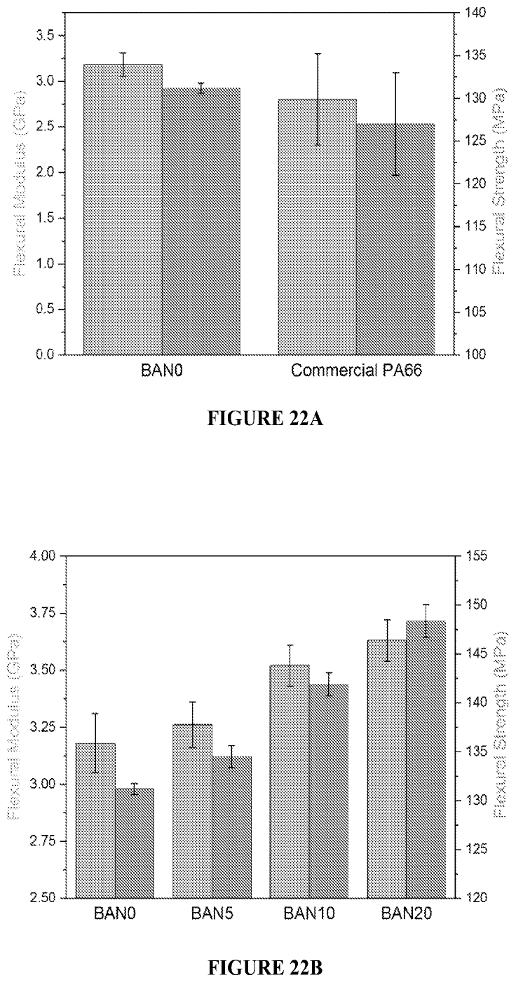

Flexural testing is another common method for evaluating mechanical properties. To determine flexural property data, a 3-point bend apparatus was used. Flexural stress versus strain plots and bar charts of derived quantities are shown in FIGS. 20, 21A-D, and 22A-B. In agreement with tensile data, flexural strain hardening was suppressed by t3HDA loading as well. This is likewise attributed to t3HDA's ability to hinder crystallization. Data collected include flexural modulus and flexural strength. For ductile polymers that yield and do not break during flexural testing, flexural strength is defined as the flexural stress at 5% strain (Caesar, “The Definitive Guide to ISO 178”; “Flexural Strength Testing of Plastics,” MatWeb Material Property Data, which are hereby incorporated by reference in their entirety). The high uncertainty associated with Commercial PA66 was due to an outlier to the downside that could not be justifiably excluded due to the limited number of specimens examined. However, regardless of exclusion or not, the flexural modulus and flexural strength of BAN0 and Commercial PA66 were identical within uncertainty. On average, both flexural modulus and flexural strength increased steadily with t3HDA loading. This further demonstrated the ability of 3HHDA to enhance amorphous region stiffness via increased hydrogen bonding and, more speculatively, RAF enhancement.

As previously noted, all mechanical property testing was performed on dry, annealed samples. Considering the extent of annealing—that is, the degree of crystallinity—and moisture content will undoubtedly influence mechanical properties, the trends observed in these tensile and flexural studies cannot easily be extrapolated to other conditions. Further mechanical property insight can be achieved by assessing moisture absorption, which has a known influence on polyamide properties.

### Moisture Absorption Testing

Due to the existence of hydrogen bonding amide linkages in the polymer chain, polyamides easily absorb water. Absorbed water molecules act as plasticizers, which change the dimensional stability of the polymer by reducing electrostatic interchain attraction. Furthermore, moisture absorption directly affects the physical and mechanical properties of polyamides (Cousin et al., “Synthesis and Properties of Polyamides from 2,5-Furandicarboxylic Acid,” J. Appl. Polym. Sci. 135 (8): 45901 (2018); Yang et al., “Synthesis and Characterization of Poly (1,6-Hexamethylene Oxamide-Co-m-Xylene Oxamide) Copolymers,” Polym. Adv. Technol. 29 (12): 2943-2951 (2018); Kohan, Nylon Plastics Handbook; Hanser Publishers; Distributed in the USA and in Canada by Hanser/Gardner Publications: Munich; New York; Cincinnati, 1995, which are hereby incorporated by reference in their entirety). In the dry state, polyamides have enhanced modulus, strength, and abrasion resistance, but this is at the expense of toughness and flexibility. To enhance toughness, yield strain, and elongation at break, polyamides are often allowed to absorb moisture in a process called conditioning (Jia et al., “Mechanical Performance of Polyamides with Influence of Moisture and Temperature—Accurate Evaluation and Better Understanding,” In Plastics Failure Analysis and Prevention; Elsevier, 2001; pp 95-104; Zytel® 101 NC010|DuPont, which are hereby incorporated by reference in their entirety). In engineering applications such as automotive parts, high strength is desirable and polyamides with reduced moisture absorption are preferred. In contrast, the flexibility of polyamides are highly desirable in the textile market, particularly in performance athletic-wear. There is therefore a strong demand for the ability to tailor polyamide properties to suit specific end-use applications, preferably with drop-in applicability.

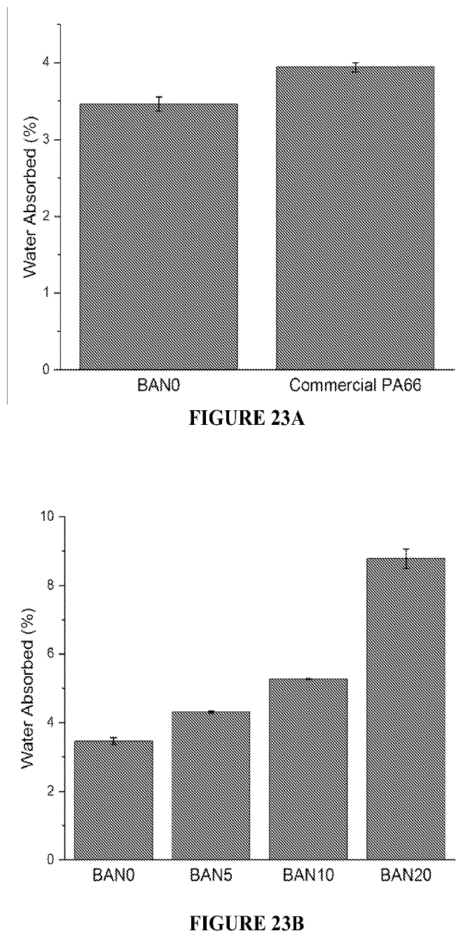

To assess the moisture absorption of BANs, unannealed Izod bars were soaked in 18 MΩ water for 12 days to approximate equilibrium moisture content. Bar charts displaying the moisture absorption of Commercial PA66 and BANs of differing t3HDA loading are shown in FIGS. 23A-B. While the moisture absorption of BAN0 was statistically lower than Commercial PA66, this difference was not intrinsic to the polymer chemistry. Rather, the discrepancy was attributed to differences in crystallinity afforded by differing injection molding conditions and possibly additives. Depending on the polyamide molded, differing injection molding conditions were used to optimize melt flow and minimize thermal degradation. It is well known that processing parameters such as melt temperature, mold temperature, and injection pressure have a significant effect on polymer properties, especially the crystallinity of semicrystalline polymers (Katti et al., “The Microstructure of Injection-Molded Semicrystalline Polymers: A Review,” Polym. Eng. Sci. 22 (16): 1001-1017 (1982), which is hereby incorporated by reference in its entirety). Reducing the crystallinity of polyamides is known to increase moisture absorption (Starkweather et al., “Effect of Crystallinity on the Properties of Nylons,” J. Polym. Sci. 21 (98): 189-204 (1956), which is hereby incorporated by reference in its entirety). While DSC experiments showed that Commercial PA66 has a higher crystallinity than in-house synthesized BAN0, this observation need not hold true under different thermal conditions. DSC and WAXS studies showed that t3HDA loading decreased crystallinity. The reduced crystallinity imparted by t3HDA loading combined with the inherent hydrophilicity of the 3HHDA hydroxyl group can markedly increase water absorption. While the effects of processing conditions cannot be ruled out, a clear trend is observed as t3HDA loading increases.

### CONCLUSION

BANs of differing composition were synthesized as a model case for assessing the impact of co-monomer loading on polymer properties. During batch polymerization, in situ t3HDA hydration to 3HHDA was observed. Co-monomers were found to partition into the amorphous and interphases while leaving the crystal phase unaltered. Increasing co-monomer content minimally decreased χ_{c} up to 20% loading. In contrast, the dynamics of the amorphous and interphases were more significantly affected. Viscoelastic properties were observed to have an increased dependence on temperature with increased loading, attributed to the hydroxyl group influence of 3HHDA on hydrogen bonding and free volume. Moisture absorption, which occurred more readily through the amorphous phase, was found to increase by more than 100% at 20% loading. However, due to the dominating influence of crystallinity, thermal and physical properties were minimally affected up to 20% loading. These results suggest that bioadvantaged co-monomers can be used to selectively alter polymer properties, namely those closely related to the amorphous and interphases. Furthermore, the structure-function relationship between co-monomer loading and thermomechanical properties outlined in the present application can be generalized to guide research on other randomly dispersed co-monomers. By utilizing bioadvantaged monomers, value can be added to established polymer products. This approach which combines bioadvantaged and bioprivileged strategies uses added value to provide the impetus for biorefinery adoption while simultaneously minimizing capital requirements for product startup. Further development and implementation of this approach will aid the development of sustainable chemical industries.

### Example 11—Compositional Screening of Bioadvantaged Nylons (BANs)

The BANs previously discussed were chosen for in-depth analysis based on their similar properties to Nylon 6,6. To identify which t3HDA compositions gave similar properties, screening was conducted over the entire composition range. To facilitate facile synthesis and screening, samples were generated using a tube furnace polymerization, which resulted in lower molecular weights.

### Polymer Synthesis

Screening quality bioadvantaged nylons (BAN*) was prepared via a polycondensation reaction between trans-3-hexenedioic acid (t3HDA), adipic acid (AA), and hexamethylenediamine (HMDA). AA and t3HDA with the molar ratio of x:(1-x), respectively, were both dissolved separately in methanol (CH₃OH), and afterward the resulting mixture with 1:1 molar ratio were mixed with HMDA, which was dissolved in CH₃OH. The reactant was then heated in a round bottom flask at 60° C. The precipitated salt, which was formed within 20 min, was filtered, washed three times with CH₃OH and left to dry in a fume hood. To complete polycondensation, the resulting salt was mixed with DI water with a mass ratio of 0.86:1, placed into aluminum pan in a tube furnace, heated at the rate of 7.5° C./min to 250-270° C., kept for 30 min under nitrogen gas purge, and then cooled to room temperature.

### Thermal Properties Measurements

Thermal studies were performed using differential scanning calorimetry (DSC) and thermogravimetric analysis (TGA). DSC experiments using polymer powder were conducted with a DSC Q2000 (TA Instruments) in aluminum hermetic pans by cycling of heating and cooling between 0 and 325° C., at heating/cooling rates of 10° C./min under N2 atmosphere with flow rate of 50 mL/min. TGA measurement of all samples were carried out using a NETZSCH STA model STA 449 F1 Jupiter thermogravimetric analyzer, on 3-5 mg weight samples in a alumina crucible pan with a heating rate of 10° C./min from room temperature to 700° C., under nitrogen atmosphere with flow rate of 20 mL/min.

Dynamic mechanical analysis (DMA) was performed using a TA instrument ARES-G2 rheometer with a 3-point bending fixture under nitrogen gas flow to prevent thermal degradation of the polymer. All the samples were cut into test specimens with dimensions of 29×5×1 mm using a Carver hydraulic press. To determine storage and loss moduli of samples, various temperature ranges from −30 to the practical limit of the sample's melting point at a heating rate of 5° C./min, a strain of 0.05% and frequency of 1 Hz was applied.

### Wide-Angle X-Ray Scattering (WAXS)

Temperature-dependent wide-angle X-ray diffraction (WAXS) measurements were performed using a XENOCS Xeuss 2.0 SWAXS system with monochromatized X-ray wavelength of λ=0.7107 Å from Mo Kα radiation. Data was collected by Pilatus 1M detector at a sample-to-detector distance of 34.72 cm calibrated by a silver behenate standard. The corresponding scattering vector (q) window was 0.1-3.5 Å. The samples were inserted into the DSC aluminum hermetic pan, sealed thoroughly, and fixed into a temperature controlled stage THMS600 from Linkam equipped with a LNP95 liquid nitrogen cooling pump. Data acquisition was collected in 20 or 30° C. intervals from room temperature until samples became melted with the heating/cooling rate of 30° C./min. Each sample was equilibrated at the desired temperature for 60 s followed by an acquisition of 60 s.

### Screening Results for Thermal Analysis

TABLE 5
Thermal and Structural Properties of BAN with Different t3HDA Loading

| | T_{g}^{a} | Tₘ^{b} | T_{c}^{c} | ΔH_{c}^{d} | T₅₀^{e} | DSC | WAXS | Mₙ^{h} | M_{w}ⁱ | |
|---|---|---|---|---|---|---|---|---|---|---|
| Sample | (° C.) | (° C.) | (° C.) | (J/g) | (° C.) | χ_{c}^{f} (%) | χ_{c}^{g} (%) | (kDa) | (kDa) | Ð^{j} |
| BAN* 0 | — | 255 | 226 | 75 | 431 | 30.0 | 51.9 | 5.61 | 11.5 | 2.06 |
| BAN* 5 | — | 250 | 224 | 64 | 430 | 32.6 | 53.6 | 6.39 | 12.7 | 2.00 |
| BAN* 20 | — | 229 | 197 | 48 | 437 | 23.0 | 44.0 | 5.57 | 11.7 | 2.11 |
| BAN* 40 | — | 195 | 157 | 35 | 444 | 21.3 | 31.6 | 5.16 | 11.2 | 2.18 |
| BAN* 50 | 44.3 | 170 | 114 | 22 | 447 | 11.5 | 23.4 | 4.95 | 10.5 | 2.21 |
| BAN* 60 | 36.1 | — | — | — | 448 | — | 21.0 | 5.13 | 11.7 | 2.28 |
| BAN* 80 | 28.6 | — | — | — | 451 | — | — | 3.82 | 10.1 | 2.65 |
| BAN* 100 | 17.6 | — | — | — | 452 | — | — | 3.27 | 8.44 | 2.58 |

^{a}Glass transition temperature determined via DSC (T_{g}).
^{b}Melting temperature (Tₘ).
^{c}Crystallization temperature (T_{c}).
^{d}Enthalpy of crystallization (ΔH_{c}).
^{e}Decomposition temperature at 50% mass loss (T₅₀).
^{f}Percent crystallinity from DSC (DSC χ_{c}).
^{g}Percent crystallinity from WAXS (WAXS χ_{c}).
^{h}Number average molecular weight based on PMMA standards (Mₙ).
ⁱWeight average molecular weight based on PMMA standards (M_{w}).
^{j}Dispersity based on PMMA standards (Ð).

Screening results showed that increasing t3HDA loading decreased the melting point (Tₘ). Tₘ continued to decrease up to 50% t3HDA loading, beyond which no melting transition was observed. Similarly, the crystallization temperature (T_{c}) decreased until the copolymer became completely amorphous. Increasing t3HDA loading decreased the glass transition temperature by over 60% at 100% loading. Using dynamic mechanical analysis (DMA), the storage modulus at 30° C. was observed to decrease with increased loading. In contrast, the loss modulus was observed to steadily increase up to 50% loading, beyond which it dropped rapidly.

DSC experiments showed a drop in crystallinity (χ_{c}) up to 50% t3HDA loading, at which point the copolymers became completely amorphous. This is with the exception of BAN5, which had slightly higher crystallinity than BAN0. Temperature dependent WAXS studies showed that t3HDA loading increased the Brill transition temperature at low loadings, but ultimately suppressed it at higher loadings because of the reduced melting temperature of BANs with high t3HDA loading.

Based on the screening results, it was found that BAN* properties begin to significantly deviate from those of Nylon 6,6 above 20% t3HDA loading. Since BAN* must be similar to Nylon 6,6 for it to be a suitable alternative, BANs with 20% or less t3HDA were chosen to be upgraded to commercial quality. The resulting high molecular weight samples were fully characterized using structural, thermal, and mechanical analyses.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A polymer comprising a moiety of formula: 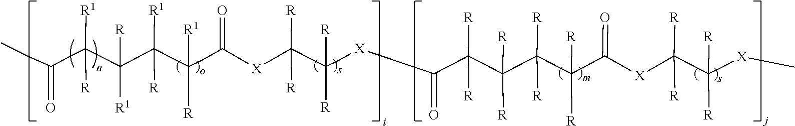
wherein
X is NH or O;
R is independently H or OH;
each R¹ is independently H or OH;
i is 1 to 1,000,000;
j is 1 to 1,000,000;
m is 1 to 30;
n is 1 to 30;
o is 1 to 30; and
s is independently 1 to 50;
with the proviso that at least one R¹ is OH,
or a salt thereof.

2. The polymer of claim 1, wherein the polymer has the structure of formula (I): 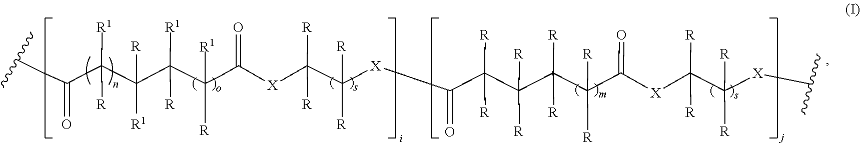
wherein [symbol]
is a terminal group of the polymer.

3. The polymer of claim 1, wherein i and j represent number average degrees of polymerization for repeat units of formula I that are distributed throughout the polymer chain in a statistically defined manner.

4. The polymer according to claim 1, wherein X is NH.

5. The polymer according to claim 1, wherein the polymer comprises a moiety of formula:

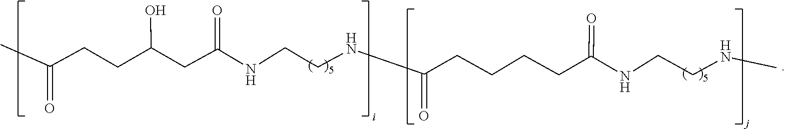

6. The polymer according to claim 1, wherein the polymer comprises a moiety of formula:

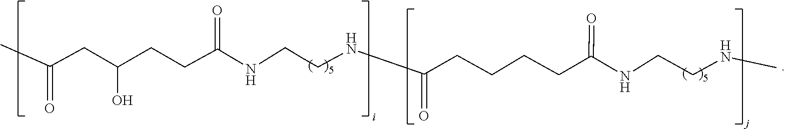

7. The polymer according to claim 5, wherein the polymer has the structure of formula (Ia):

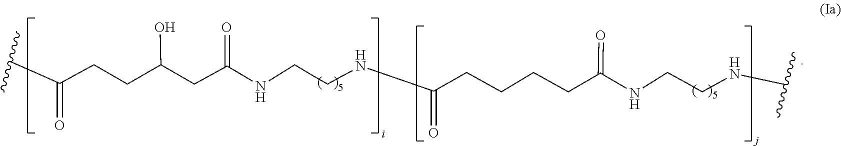

8. The polymer according to claim 6, wherein the polymer has the structure of formula (Ib):

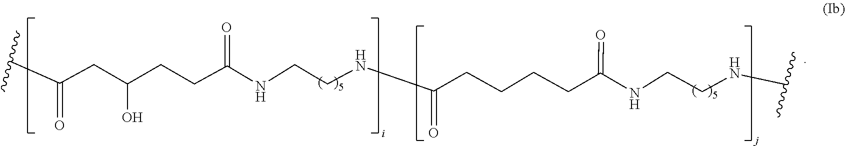

9. The polymer according to claim 1, wherein i is 10 to 1,000,000 and j is 10 to 1,000,000.

10. The polymer according to claim 1, wherein i is 20 to 1,000,000 and j is 20 to 1,000,000.

11. The polymer according to claim 1, wherein i is 30 to 1,000,000 and j is 30 to 1,000,000.

12. The polymer according to claim 1, wherein i is 40 to 1,000,000 and j is 40 to 1,000,000.

13. The polymer according to claim 1, wherein the polymer has a molecular weight (Mₙ) above 5 kDa.

14. The polymer according to claim 1, wherein the polymer has a molecular weight (Mₙ) above 10 kDa.

15. The polymer according to claim 1, wherein the polymer has a molecular weight (Mₙ) above 15 kDa.

16. A process for preparation of a polymer comprising a moiety of formula: 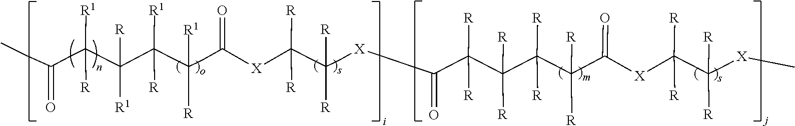
wherein
X is NH or O;
R is independently H or OH;
each R¹ is independently H or OH;
i is 1 to 1,000,000;
j is 1 to 1,000,000;
m is 1 to 30;
n is 1 to 30;
o is 1 to 30; and
s is independently 1 to 50;
with the proviso that at least one R¹ is OH,
or a salt thereof,
said process comprising:
providing a compound having the structure of formula (II): 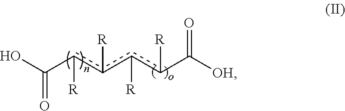
wherein each [symbol] is independently a single or a double bond with no adjacent double bonds, and wherein at least one [symbol] is a double bond;
providing a compound having the structure of formula (III): 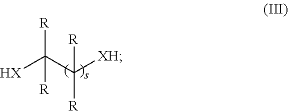
providing a compound having the structure of formula (IV): 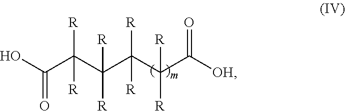
and
reacting the compound of formula (II), the compound of formula (III), and the compound of formula (IV) under conditions effective to produce the polymer.

17. The process according to claim 16, wherein the polymer has a Formula (I): 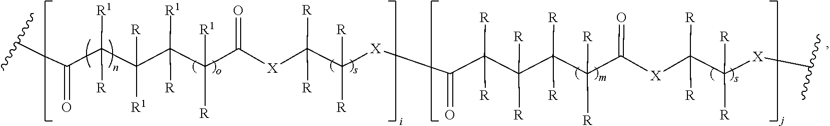
wherein [symbol]
is a terminal group of the polymer.

18. The process according to claim 16, wherein the polymer comprises a moiety of formula:

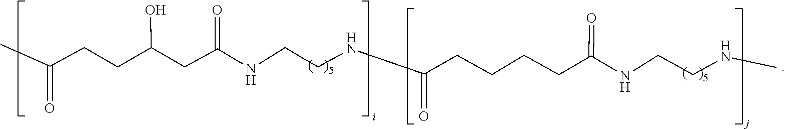

19. The process according to claim 16, wherein the polymer comprises a moiety of formula:

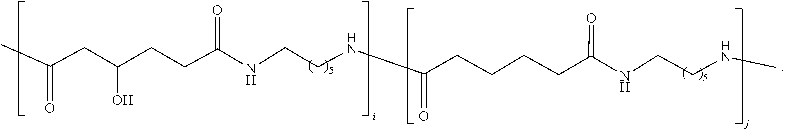

20. The process according to claim 18, wherein the polymer has the structure of Formula (Ia):

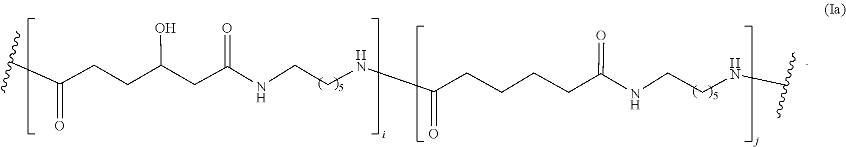

21. The process according to claim 19, wherein the polymer has the structure of Formula (Ib):

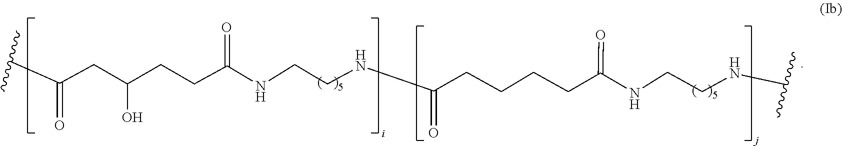

22. The process according to claim 16, wherein i is 10 to 1,000,000 and j is 10 to 1,000,000.

23. The process according to claim 16, wherein i is 20 to 1,000,000 and j is 20 to 1,000,000.

24. The process according to claim 16, wherein i is 30 to 1,000,000 and j is 30 to 1,000,000.

25. The process according to claim 16, wherein i is 40 to 1,000,000 and j is 40 to 1,000,000.

26. The process according to claim 16, wherein the polymer has a molecular weight (Mₙ) above 5 kDa.

27. The process according to claim 16, wherein the polymer has a molecular weight (Mₙ) above 10 kDa.

28. The process according to claim 16, wherein the polymer has a molecular weight (Mₙ) above 15 kDa.

29. The process according to claim 16, wherein i and j represent number average degrees of polymerization for repeat units of formula I that are distributed throughout the polymer chain in a statistically defined manner.

30. The process according to claim 16, wherein said reacting the compound of formula (II), the compound of formula (III), and the compound of formula (IV) comprises:
reacting the compound of formula (II) with the compound of formula (III) to form a salt 1;
reacting the compound of formula (IV) with the compound of formula (III) to form a salt 2; and
reacting the salt 1 with the salt 2 under conditions effective to produce the polymer.

31. The process according to claim 30, wherein said reacting the salt 1 with the salt 2 comprises:
heating the salt 1 with the salt 2 under inert atmosphere in a reaction vessel.

32. The process according to claim 31, wherein said heating is conducted under pressure.

33. The process according to claim 31 further comprising:
venting the reaction vessel at least once during said heating.

34. A textile treatment composition comprising the polymer of claim 1.

35. A method for impregnating textiles comprising impregnating a textile with a composition comprising the polymer of claim 1.

36. The process according to claim 16, wherein said reacting is carried out in the presence of water.

37. The process according to claim 16, wherein said reacting is carried out at a pressure of 10 to 1000 psig.

38. The process according to claim 16, wherein said reacting is carried out at a pressure of 200 to 400 psig.

39. The process according to claim 16, wherein said reacting is carried out at a pressure of 250 to 350 psig.

40. The process according to claim 16, wherein said reacting is carried out under vacuum.
